(19) United States
(12) Patent Application Publication
(10) Pub. No.: US 2010/0144365 A1
(43) Pub. Date: Jun. 10, 2010

(54) WIRELESS BASE STATION, LOAD DISTRIBUTION APPARATUS, CENTRALIZED CONTROL APPARATUS, WIRELESS COMMUNICATION SYSTEM, LOAD DISTRIBUTION METHOD AND LOAD DISTRIBUTION PROGRAM

(76) Inventors: Huanxu Pan, Tokyo (JP); Daisuke Kawasaki, Tokyo (JP); Satoru Yamano, Tokyo (JP)

Correspondence Address: Mr. Jackson Chen, 6535 N. STATE HWY 161, IRVING, TX, 75039, US

(21) Appl. No.: 12/307,544

(22) PCT Filed: Jul. 3, 2007
(86) PCT No.: PCT/JP2007/063327

§ 371 Date: Feb. 15, 2010

(30) Foreign Application Priority Data
Jul. 5, 2006 (JP) 2006-186012

(51) Int. Cl. H04W 72/04

(52) U.S. Cl. 455/453

(57) ABSTRACT

The present invention aims at providing a wireless communication system capable of lowering the load of the overload channel in the overload state in consideration of the allocation states of radio channels of adjacent base stations adjacent to the wireless base station. The wireless communication system in accordance with the present invention includes a plurality of wireless base stations (AP) capable of allocating a plurality of radio channels to be used for wireless communication and a load distribution apparatus (1) to conduct load distribution for a radio channel being used in the wireless base stations (AP) wherein the apparatus (1) obtains allocation states of radio channels of the respective wireless base stations (AP) to detect, on the basis of the obtained allocation states, an overload wireless base station (AP) which is using an overload radio channel in an overload state. Thereafter, the apparatus (1) allocates, on the basis of the obtained allocation states, a new channel to the overload wireless base stations (AP) to thereby conduct load distribution for the overload radio channel.

### TECHNICAL FIELD

The present invention relates to a wireless base station, a load distribution apparatus, a centralized control apparatus, a wireless communication system, a load distribution method, and a load distribution program in which when an overload radio channel in an overload state is detected in radio channels being used by respective wireless base stations, load distribution is carried out for the overload channel.

### RELATED ART

Recently, there has been widely employed by users a Wireless Local Area Network (WLAN) system represented by Institute of Electrical and Electronics Engineers (IEEE) 802.11x (x collectively indicates a, b, g, etc.) Therefore, it is possible for each user to arbitrarily install a wireless base station (Access Point (AP)) in a radio environment to conduct wireless communication via the wireless base station (AP).

Incidentally, when a 2.4 GHz band is applied to the wireless communication, radio channels which do not interfere with each other in the frequency allocation of the 2.4 GHz band are only four channels (e.g., 1ch, 6ch, 11ch, 14ch) at the maximum at present in Japan. However, the range of radio channels varies depending on wireless systems and countries; it is hence natural that the number of radio channels which do not interfere with each other varies depending on wireless systems and countries.

Therefore, the cell designing is desirably carried out with the intention such that different radio channels are allocated to the respective wireless base stations (AP).

However, recently, since each user can arbitrarily install a wireless base station (AP) in the radio environment, it is a common practice that the cell designing described above is not employed.

Additionally, also in operation of the wireless communication system, the traffic condition for each cell configured by each wireless base station (AP) is likely to be easily changed; in general, the load state is ill-balanced between radio channels used by the respective wireless base stations (AP).

However, in consideration of use of applications requiring high communication quality (Quality of Service (QoS)) as in the IP telephone communication using the wireless LAN (Voice Over Wireless Local Area Network (VoWLAN)), there is required a control method to remove the imbalance of the load state between the radio channels used by the respective wireless base stations (AP).

Also, if a radio channel being used by each wireless base station (AP) enters a load state (an overload state) satisfying a predetermined condition, it is difficult to keep high communication quality; there is hence required a control method to conduct load distribution for the radio channel in the overload state.

There exists a technical article filed by the inventors of the present invention in consideration of the above situation, the article disclosing a dynamic load distribution method for use with a wireless access communication network including a plurality of base stations and a resource allocation computer which calculates allocation to control resources including at least a frequency for the plural base stations (reference is to be made to, for example, patent document 1).

The dynamic load distribution method disclosed in patent document 1 is characterized in that on the resource allocation computer side, there are carried out a first step of conducting fixed allocation resource calculation to secure connections in all areas managed by the plural base stations and a second step of calculating dynamic allocation resources to be allocated to the plural base stations for load distribution, to thereby allocate the resources according to frequencies to be handled by the first and second steps.

However, in the wireless communication system, there generally exist a small number of available radio channels not causing interference therebetween (at most four channels are available in the case of the wireless LAN); in consideration of a situation in which the intentional cell designing described above is not employed, it is hardly expectable in the present state to obtain the condition to adopt the dynamic load distribution method disclosed in patent document 1.

That is, in the dynamic load distribution method disclosed in patent document 1; first, fixed resources (radio channels) to secure connections in all areas are separated in advance from dynamic resources (radio channels) to be allocated for the load distribution. Thereafter, in a situation wherein an overload radio channel in an overload state is detected in a state in which fixed resources (radio channels) are being used in arbitrary base stations, a dynamic resource (radio channel) is directly allocated for load distribution to the base station which has detected the overload radio channel.

However, as in the dynamic load distribution method disclosed in patent document 1, the radio channels for the fixed resources and those for the dynamic resources are separated from each other in advance, which does not lead to an effective use of radio channels; as a result, this method cannot be regarded as suitable to lower the load on the radio channels.

Hence, there is required a control method in which a wireless base station capable of freely allocating a plurality of radio channels to be used for wireless communication such that at detection of an overload radio channel in an overload state by the wireless base station, the load of the overload channel is lowered in consideration of a radio channel allocation state of an adjacent wireless base station adjacent to the wireless base station.

In this connection, there is a technical article filed before the present invention, the article disclosing a cellular mobile communication system in which an unused wireless communication channel is allocated to each mobile station for communication, the system being characterized in that the mobile station includes means for determining whether or not the mobile station locates in an interference area (indicating an area in which a locating mobile station can conduct wireless communication with a plurality of base stations; this applies to the description below) and means which allocates, when the mobile station conducts communication outside the interference area, an unused wireless communication channel only in a service area in which the mobile terminal locates (indicates an area in which a locating mobile station can conduct wireless communication with base stations constituting the pertinent area; this applies to the description below), and which allocates, when the mobile station conducts communication within the interference area, an unused wireless communication channel in all service areas constituting the interference area (reference is to be made to, for example, patent document 2).

Additionally, there exists an article disclosing a wireless communication apparatus operating in a communication environment in which communication is conducted with different frequency bands using a shared modulation scheme, the wireless communication apparatus including a plurality of transceiver sections to communicate transmission data of respective frequency bands, a master frequency supply section to supply a master frequency for modulation and demodulation in the respective frequency bands, and a modem section to modulate and to demodulate the transmission data of the respective frequency bands by use of the master frequency for the modulation and demodulation supplied from the master frequency supply section, the wireless communication apparatus being capable of conducting wireless communication in both environments including indoor and outdoor environments by using a 2.4 GHz band in the outdoor and 5.2 GHz in the indoor (reference is to be made to, for example, patent document 3).

Furthermore, there exists an article disclosing a wireless base station characterized by comprising control means for use with a wireless base station corresponding to a code division multiplexing communication scheme, the means controlling the number of radio channels allowed to be allocated in a cell of the own station based on information regarding allocation states of radio channels in adjacent wireless base stations (reference is to be made to, for example, patent document 4).

Moreover, there exists an article disclosing a wireless communication device to conduct wireless communication by use of one of a plurality of channels obtained by dividing a predetermined frequency band, the wireless communication device including wireless communication means to conduct modulation and demodulation for data to carry out wireless communication, detection means to detect an available channel, setting means to set the channel detected by the detection means as a communication channel for wireless communication to be carried out via the wireless communication means, wired communication means to conduct wired communication with a wired network, and connection means to connect a wireless network to conduct wireless communication using the channel to the wired network, the wireless communication device being capable of automatically setting a free channel, which is not used for communication, as a communication channel (reference is to be made to, for example, patent document 5).

In addition, there exists an article disclosing a method of analyzing a band utilization quantity (reference is to be made to, for example, non-patent document 1).

Patent Document 1: Japanese Patent Laid-Open Publication Ser. No. 2005-333625
Patent Document 2: Japanese Patent Laid-Open Publication Ser. No. 2000-102062
Patent Document 3: Japanese Patent Laid-Open Publication Ser. No. 2003-101506
Patent Document 4: Japanese Patent Laid-Open Publication Ser. No. 2005-123794
Patent Document 5: Japanese Patent Ser. No. 3600568
Non-Patent Document 1: Han, “An Analysis of the Bandwidth Usage in VoWLAN”, Transactions of 2005 IEEE Society Conference, September 2005, pp. B-6-126

### DISCLOSURE OF THE INVENTION

### Problem to be Solved by the Invention

However, in patent documents 2 to 5, description has not been given of an operation in which when a wireless base station detects an overload channel in an overload state, the load of the overload radio channel is lowered in consideration of allocation states of radio channels of adjacent base stations adjacent to the wireless base station.

The present invention has been devised in consideration of the situation above and aims at providing a wireless base station, a load distribution apparatus, a centralized control apparatus, a wireless communication system, a load distribution method, and a load distribution program capable of achieving the object described above, i.e., lowering the load of the overload radio channel in the overload state in consideration of the allocation states of radio channels of adjacent base stations adjacent to the wireless base station.

### Means for Solving the Problem

To achieve the object, the present invention has characteristics as below.

The wireless base station in accordance with the present invention is a wireless base station capable of allocating a plurality of radio channels to be used for wireless communication, characterized by including:

allocation state acquiring means for acquiring allocation states of radio channels of adjacent wireless base stations adjacent to the wireless base station;

load detecting means for detecting an overload radio channel in an overload state in radio channels being used by the wireless base station; and

load distributing means for allocating a new radio channel on the basis of the allocation states acquired by the allocation state acquiring means and conducting load distribution for the overload radio channel.

In addition, the load distribution apparatus in accordance with the present invention is a load distribution apparatus connected to a plurality of wireless base stations capable of allocating a plurality of radio channels to be used for wireless communication for conducting load distribution for a radio channel being used in the wireless base stations, characterized by including:

allocation state acquiring means for acquiring allocation states of radio channels of respective wireless base stations;

load detecting means for detecting an overload wireless base station using an overload radio channel in an overload state on the basis of the allocation states acquired by the allocation state acquiring means; and

load distributing means for allocating a new radio channel to the overload wireless base station on the basis of the allocation states acquired by the allocation state acquiring means and conducting load distribution for the overload radio channel.

Furthermore, the centralized control apparatus in accordance with the present invention is a centralized control apparatus on which the load distribution apparatus described above is mounted, characterized by including:

wireless base station control means for conducting centralized control of the plural wireless base stations.

Also, the wireless base station in accordance with the present invention is a wireless base station characterized in that:

the load distribution apparatus described above is mounted in the apparatus.

Moreover, the wireless communication system in accordance with the present invention is a wireless communication system including a plurality of wireless base stations capable of allocating a plurality of radio channels to be used for wireless communication, characterized in that

the wireless base station includes:

allocation state acquiring means for acquiring allocation states of radio channels of adjacent wireless base stations adjacent to the wireless base station;

load detecting means for detecting an overload radio channel in an overload state in radio channels being used by the wireless base station; and

load distributing means for allocating a new radio channel on the basis of the allocation states acquired by the allocation state acquiring means and conducting load distribution for the overload radio channel.

Additionally, the wireless communication system in accordance with the present invention is a wireless communication system including a plurality of wireless base stations capable of allocating a plurality of radio channels to be used for wireless communication, characterized in that

the wireless base station includes:

allocation state acquiring means for acquiring allocation states of radio channels of respective wireless base stations;

load detecting means for detecting an overload wireless base station using an overload radio channel in an overload state on the basis of the allocation states acquired by the allocation state acquiring means; and

load distributing means for allocating a new radio channel to the overload wireless base station on the basis of the allocation states acquired by the allocation state acquiring means and conducting load distribution for the overload radio channel.

Also, the wireless communication system in accordance with the present invention is a wireless communication system including a plurality of wireless base stations capable of allocating a plurality of radio channels to be used for wireless communication and a load distribution apparatus for conducting load distribution for a radio channel being used in the wireless base stations, characterized in that

load distribution apparatus includes:

allocation state acquiring means for acquiring allocation states of radio channels of respective wireless base stations;

load detecting means for detecting an overload wireless base station using an overload radio channel in an overload state on the basis of the allocation states acquired by the allocation state acquiring means; and

load distributing means for allocating a new radio channel to the overload wireless base station on the basis of the allocation states acquired by the allocation state acquiring means and conducting load distribution for the overload radio channel.

In addition, the load distribution method in accordance with the present invention is a load distribution method for use in a wireless base station capable of allocating a plurality of radio channels to be used for wireless communication, characterized in that the wireless base station carries out:

an allocation state acquiring step for acquiring allocation states of radio channels of adjacent wireless base stations adjacent to the wireless base station;

a load detecting step for detecting an overload radio channel in an overload state in radio channels being used by the wireless base station; and

a load distributing step for allocating a new radio channel on the basis of the allocation states acquired by the allocation state acquiring means and conducting load distribution for the overload radio channel.

Furthermore, the load distribution method in accordance with the present invention is a load distribution method for use with a load distribution apparatus connected to a plurality of wireless base stations capable of allocating a plurality of radio channels to be used for wireless communication for conducting load distribution for a radio channel being used in the wireless base stations, characterized in that the load distribution apparatus carries out:

an allocation state acquiring step for acquiring allocation states of radio channels of respective wireless base stations;

a load detecting step for detecting an overload wireless base station using an overload radio channel in an overload state on the basis of the allocation states acquired by the allocation state acquiring step; and

a load distributing step for allocating a new radio channel to the overload wireless base station on the basis of the allocation states acquired by the allocation state acquiring step and conducting load distribution for the overload radio channel.

Additionally, the load distribution program in accordance with the present invention is a load distribution program to be executed in a wireless base station capable of allocating a plurality of radio channels to be used for wireless communication, characterized in that the wireless base station is made to execute:

allocation state acquiring processing for acquiring allocation states of radio channels of adjacent wireless base stations adjacent to the wireless base station;

load detecting processing for detecting an overload radio channel in an overload state in radio channels being used by the wireless base station; and

load distributing processing for allocating a new radio channel on the basis of the allocation states acquired by the allocation state acquiring processing and conducting load distribution for the overload radio channel.

Moreover, the load distribution program in accordance with the present invention is a load distribution program to be executed in a load distribution apparatus connected to a plurality of wireless base stations capable of allocating a plurality of radio channels to be used for wireless communication for conducting load distribution for a radio channel being used in the wireless base stations, characterized in that the load distribution apparatus is made to execute:

allocation state acquiring processing for acquiring allocation states of radio channels of respective wireless base stations;

load detecting processing for detecting an overload wireless base station using an overload radio channel in an overload state on the basis of the allocation states acquired by the allocation state acquiring processing; and

load distributing processing for allocating a new radio channel to the overload wireless base station on the basis of the allocation states acquired by the allocation state acquiring processing and conducting load distribution for the overload radio channel.

### ADVANTAGE OF THE INVENTION

In accordance with the present invention, it is possible to lower the load of the overload radio channel in the overload state in consideration of the allocation states of radio channels of adjacent base stations adjacent to the wireless base station.

### BEST MODE FOR CARRYING OUT THE INVENTION

First, description will be given of an outline of a wireless communication system in the embodiment. In this regard, FIG. 1 shows a system configuration of the wireless communication system in the embodiment, and FIG. 2 is a diagram to explain a load distribution method in the wireless communication system of the embodiment.

The first wireless communication system of the embodiment is a wireless communication system including as shown in FIG. 1 a plurality of wireless base stations (AP) capable of freely allocating a plurality of radio channels (e.g., CH1 to CH3) to be used for wireless communication and a load distribution apparatus (1) to conduct load distribution for radio channels employed in the wireless base stations (AP).

In this situation, the load distribution apparatus (1) acquires an allocation state of radio channels of each wireless base station (AP). Next, when the apparatus (1) detects an overload wireless base station (corresponding to cell A) using an overload radio channel (CH1) in an overload state as shown in FIG. 2(a) to FIG. 2(c) on the basis of the allocation states of radio channels of the respective wireless base stations (AP), the apparatus (1) allocates a new channel to the overload wireless base station (corresponding to cell A) as shown in FIG. 2(a) to FIG. 2(c) on the basis of the allocation states of radio channels of the wireless base stations (AP) to conduct load distribution for the overload radio channel (CH1).

Due to the operation, the load distribution apparatus (1) is capable of, at detection of an overload radio channel (CH1) in an overload state in the wireless base station (cell A), lowering the load of the overload radio channel (CH1) in consideration of the allocation states of radio channels of an adjacent wireless base station (cell B) adjacent to the wireless base station (cell A). Next, referring to the accompanying drawings, description will be given in detail of the wireless communication system of the embodiment.

### First Exemplary Embodiment

### System Configuration of Wireless Communication System

First, by referring to FIG. 1, description will be given of a system configuration of the wireless communication system of the embodiment.

The wireless communication system of the embodiment includes as shown in FIG. 1 a load distribution apparatus (1), wireless base stations (AP), and wireless terminals (STA).

The load distribution apparatus (1) is an information processing apparatus which allocates radio channels to the respective wireless base stations (AP) to conduct load distribution for the radio channels used in the respective wireless base stations (AP).

Incidentally, as the load distribution apparatus (1) of the embodiment, there may be used a server device to conduct load distribution for the radio channels of the respective wireless base stations (AP) as well as a centralized control apparatus and a wireless base station (AP) which supervise the respective wireless base stations (AP) to conduct centralized control thereof.

The wireless base station (AP) constructs a wirelessly communicable area (cell) to conduct wireless communication by use of a wireless terminal (STA) and a radio channel existing in the constructed cell.

In this connection, the wireless base station (AP) of the embodiment is capable of freely allocating radio channels available for wireless communication and conducts wireless communication with a wireless terminal (STA) using one radio channel or a plurality of radio channels.

The wireless terminal (STA) is a terminal to conduct wireless communication and is a wireless apparatus, for example, a portable telephone, a Personal Digital Assistance (PDA), or a Personal Computer (PC).

### (Load Distribution Method in the Embodiment)

Next, referring to FIG. 2, description will be given of a control method of the load distribution method in the wireless communication system of the embodiment.

As the control method of the load distribution method in the embodiment, there may be cited, as shown in FIG. 2, (a) control method of “channel addition (when a free channel exists in the periphery)”, (b) control method of “channel sharing (when a free channel does not exist in the periphery)”, (c) control method of “channel reallocation (when a free channel does not exist in the periphery)”, and (d) control method of “channel recall”.

### (a) Control Method of “Channel Addition (Where a Free Channel Exists in the Periphery)”

According to the control method of FIG. 2(a) “channel addition (where a free channel exists in the periphery)”, when a radio channel (CH1) in an overload state exists in cell A, whether or not an unused free channel (CH3) exists in an adjacent cell B existing in the proximity of the cell A is determined.

Thereafter, according to the control method, if it is determined that an unused free channel (CH3) exists in the adjacent cell B, the unused free channel (CH3) is added to cell A, the added free channel (CH3) is additionally allocated to cell A such that cell A exclusively adopts two radio channels (CH1, CH3).

In this situation, cell A additionally allocates the free channel (CH3) not used in the adjacent cell B, and it is hence possible to mitigate the overload state of the radio channel (CH1) being used in cell A. Also, the adjacent cell B is not affected by the allocation of the radio channel (CH3) to cell A.

### (b) Control Method of “Channel Sharing (When a Free Channel Does Not Exist in the Periphery)”

According to the control method of FIG. 2(b) “channel sharing (when a free channel does not exist in the periphery)”, if it is determined that an unused free channel does not exist in the adjacent cell B existing in the proximity of cell A, a radio channel (CH2) being used by the adjacent cell B is shared by cells B and A such that cell A uses two radio channels (CH1, CH2).

In this case, cell A additionally allocates the radio channel (CH2) being used by the adjacent cell B, and it is hence possible to lower the overload state of the radio channel (CH1) being used by cell A.

However, for the control method above, in a situation wherein there exist a wireless terminal (STA) which can receive signals from both wireless base stations including a wireless base station (AP) configuring cell A and a wireless base station (AP) configuring cell B, interference occurs between cells A and B, and hence the advantage to lower or to mitigate the overload state of cell A is mitigated as compared with the case of the control method of FIG. 2(a). In addition, cell B is also influenced; as a result, there appears a tendency to increase the load state of cell B.

Therefore, the control method of FIG. 2(b) “channel sharing (when a free channel does not exist in the periphery)” is favorably applied to a situation wherein it is determined that the control method of FIG. 2(a) “channel addition (where a free channel exists in the periphery)” is not applicable.

### (c) Control Method of “Channel Reallocation (When a Free Channel Does Not Exist in the Periphery)”

According to the control method of FIG. 2(c) “channel reallocation (when a free channel does not exist in the periphery)”, if it is determined that there does not exist a free channel not being used by the adjacent cell B existing in the vicinity of cell A, the radio channel (CH2) being used in the adjacent cell B is transferred to cell A. Then, in the control method, cell A uses two radio channels (CH1, CH2) and the adjacent cell B acquires a new free cell or a shared channel (CH3) to use the acquired free channel or the shared channel (CH3).

In this situation, cell A additionally allocates the radio channel (CH2) being used in the adjacent cell B, and hence it is possible to mitigate the overload state of the radio channel (CH1) being used in the adjacent cell A.

However, in the case of the control method, cell B acquires the new free channel or the shared channel (CH3) and hence exerts influence upon the cells adjacent thereto.

Therefore, the control method of FIG. 2(c) “channel reallocation (when a free channel does not exist in the periphery)” is favorably applied to a situation wherein the overload state of cell A is extremely undesirable and the overload state of cell A cannot be removed even by use of the control method of FIG. 2(b) “channel sharing (when a free channel does not exist in the periphery)”.

### Control Method of (d) “Channel Recall”

The control method of FIG. 2(d) “channel recall”> is a control method used in a situation wherein it is determined, in cell A which has come to use a plurality of radio channels according to the control methods of FIGS. 2(a) to 2(c) described above, that the overload state is removed and the number of channels to be used by cell A can be lowered.

As a result, it is possible to discard the channel (CH2) being used by cell A to prepare an environment state in which the control methods of FIGS. 2(a) to 2(c) described above can be continuously carried out.

Next, referring to FIG. 3, description will be given of cell structure configured by each wireless base station (AP) and the load state of radio channels used in the cell according to the embodiment.

Each wireless base station (AP) configuring the wireless communication system of the embodiment configures a cell shown in FIG. 3 to conduct wireless communication with a wireless terminal (STA) in the range of the configured cell.

Incidentally, in FIG. 3, the range of the cell constructed by each wireless base station (AP) is indicated by a circle. The respective wireless base stations (AP) conduct a changeover between radio channels and a simultaneous use of a plurality of radio channels in the ranges of the cells constructed by the respective wireless base stations (AP).

For example, in the case of the cell structure shown in FIG. 3, cell A is adjacent to cells B, C, and E. In addition, cell B is adjacent only to cell A. Also, cell C is adjacent to cells A, D, and E. Moreover, cell D is adjacent to cells C and E. Also, cell E is adjacent to cells A, C, and D.

Furthermore, in the cell structure shown in FIG. 3, when each cell shares a radio channel with an adjacent cell, if a wireless terminal (STA) existing in a shared cover area (in which cells overlap with each other) carries out wireless communication using the shared channel, the load state is increased due to interference not only in the cell associated with the wireless terminal (STA), but also in the adjacent cell sharing the radio channel.

Incidentally, in the embodiment a load degree is employed as a condition to determine a radio channel in an overload state as shown in FIG. 3.

In this connection, the load degree in each cell is represented by a numeric value in FIG. 3. In the embodiment, if the load degree is equal to or more than ten, it is assumed as an overload state.

In this case, in the cell structure shown in FIG. 3, only cell A is in the overload state, and it is one object of the embodiment to remove the overload state of cell A.

Additionally, although two radio channels are employed in cell D, it is also one object of the embodiment that if it is determined that the overload state does not occur by using one radio channel, the number of channels to be used by cell D is restored to one.

Incidentally, in the embodiment, the load degree is adopted as a condition to determine a radio channel in the overload state as described above; however, the condition is not limited to the load degree, but it is possible to construct the system to determine a radio channel in the overload state on the basis of any available condition.

Furthermore, in FIG. 3, an overload state is assumed when the load degree is equal to or more than ten; however, it is possible to arbitrarily set and to change the threshold value of the load degree to assume the overload state.

Incidentally, in a situation wherein the load degree is employed as the condition to determine a radio channel in the overload state as in the embodiment, it is desirable that the load degree reflects utilization ratios of the radio channels used by the wireless base station (AP) and the wireless terminal (STA).

In addition, the load degree favorably reflects overhead of the physical layer and the MAC layer. Additionally, it is favorable that the load degree also reflects transmission errors in the wireless communication and data retransmission due to collision between frames.

In this connection, the transmission rate may vary depending on a communication condition of the wireless terminal (STA).

For example, even for one and the same data size, if the transmission rate is low, the occupation time of the radio channel, namely, the load state thereof becomes large. Therefore, the load degree favorably reflects the communication condition and the like of the wireless terminal (STA).

Also, in a wireless communication system applied to VoWLAN, if the traffic conditions such as the audio coding scheme and the packet period as well as the transmission conditions such as the transmission rate and the transmission error rate are completely equal for the respective wireless terminals (STA), it is possible to simply use, as the load degree, the number of wireless terminals (STA) being used for a call.

Incidentally, according to the embodiment, the load distribution apparatus (1) measures the load degree in the cell configured by each wireless base station (AP) on the basis of information obtained from each wireless base station (AP). If it is possible for the load distribution apparatus to manage the measured load degree, the information which the load distribution apparatus (1) attains from each wireless base station (AP) and the method to be used by the apparatus (1) to measure the load degree are not particularly restricted; the load distribution apparatus (1) is capable of measuring, based on the information obtained from each wireless base station (AP), the load degree in the cell configured by each wireless base station (AP) by use of any available measuring methods.

For example, the load degree in the cell configured by each wireless base station (AP) may be measured by applying “An Analysis of the Bandwidth Usage in VoWLAN” (Han, “An Analysis of the Bandwidth Usage in VoWLAN”, Transactions of 2005 IEEE Society Conference, September 2005, pp. B-6-126).

### Load Distribution Apparatus: 1 Internal Configuration

Subsequently, referring to FIG. 4, description will be given of an internal configuration of the load distribution apparatus (1) configuring the wireless communication system of the embodiment.

The load distribution apparatus (1) of the embodiment includes, as FIG. 4 shows, a load degree measuring module (11), a load degree information input module (12), a cell duplication measuring module (13), a cell duplication information input module (14), a channel allocation determination module (15), and a channel allocation control module (16).

The load degree measuring module (11) monitors the load state of each cell.

In this regard, the measuring module (11) measures, based on information obtained from each wireless base station (AP), load degree information for each radio channel of each cell. Thereafter, the module (11) inputs the load degree information measured for each radio channel of each cell to the load degree information input module (12).

The input module (12) feeds the load degree information inputted from the measuring module (11) to the channel allocation determination module (15).

Incidentally, the load degree information measured by the load degree measuring module (11) is information regarding an allocation state of each radio channel used by each cell and a load state of the radio channel (information shown in FIG. 3).

The cell duplication measuring module (13) monitors a state of a duplicated area between the respective cells.

In this connection, the measuring module (13) measures, based on information attained from each wireless base station (AP), information (cell duplication information) of duplicated areas between the respective cells. Thereafter, the measuring module (13) feeds the measured information to the cell duplication information input module (14).

The input module (14) delivers the cell duplication information inputted from the measuring module (13) to the channel allocation determination module (15).

Incidentally, the cell duplication information measured by the cell duplication measuring module (13) is information regarding a duplication state between cells, a cell to which a wireless terminal (STA) existing in a cover area (duplicated area) shared between the cells belongs, a radio channel used by the wireless terminal (STA) and the load degree of the radio channel.

The channel allocation determination module (15) determines, based on the load degree information received from the load degree information input module (12) and the cell duplication information received from the cell duplication information input module (14), whether or not the control method of (a) “channel addition (when a free channel exists in the periphery)”, (b) “channel sharing (when a free channel does not exist in the periphery)”, (c) “channel reallocation (when a free channel does not exist in the periphery)”, or “channel recall” shown in FIG. 2 is to be conducted.

In this connection, the channel allocation determination module (15) includes, as FIG. 15 shows, a data storage (150) and a channel allocation calculation module (151).

The data storage (150) stores and manages the load degree information and the cell duplication information inputted to the channel allocation determination module (15).

FIGS. 6 and 7 show table layout examples to store the load degree information and the cell duplication information stored in the data storage (150).

FIG. 6 shows a table layout example used to manage the load degree information stored in the data storage (150) and FIG. 7 shows a table layout example employed to manage the cell duplication information stored in the data storage (150).

The data storage (150) manages each used channel used in each cell and the load degree of the used channel as shown, for example, in FIG. 6.

In this connection, the load degree information shown in FIG. 6 indicates a used channel of each cell and the load degree of the used channel in the cell structure shown in FIG. 3.

For example, it is indicated that cell A uses the radio channel (CH1) and the load degree thereof is 11. Also, it is indicated that cell B uses the radio channel (CH2) and the load degree thereof is three. Similarly, it is indicated that cell C uses the radio channel (CH3) and the load degree thereof is five. Furthermore, it is indicated that cell D uses the radio channels (CH1, CH2) and the load degree of the used channel (CH1) is six and that of the used channel (CH2) is two. Also, it is indicated that cell E uses the radio channel (CH2) and the load degree thereof is three.

The data storage (150) manages the duplication state (overlapping) between the cells and the load degree of each used channel between the cells, for example, as shown in FIG. 7.

Incidentally, * shown in FIG. 7 indicates a duplicated state between cells.

For example, it is indicated that cell A overlaps with cells B, C, and E. Also, it is indicated that cell B overlaps with cell A. Additionally, it is indicated that cell C overlaps with cells A, D, and E. Similarly, it is indicated that cell D overlaps with cells C and E. Moreover, it is indicated that cell E overlaps with cells A, C, and D.

Furthermore, FIG. 7 shows the load degree of each radio channel in a duplicated area for each belonging cell (a cell shown on the left side of FIG. 7).

For example, for cell A, it is indicated that in a wireless terminal (STA) belonging to cell A, no load degree exists for a radio channel in the duplicated area with respect to cell B as “*(0,0,0)”; also, in the wireless terminal (STA) belonging to cell A, a load degree of one exists for a radio channel (CH1) in the duplicated area with respect to cell C as “*(1,0,0)”; furthermore, in the wireless terminal (STA) belonging to cell A, a load degree of one exists for the radio channel (CH1) in the duplicated area with respect to cell E as “(1,0,0)”.

Also, for cell B, in a wireless terminal (STA) belonging to cell B, it is indicated that a load degree of one exists for a radio channel (CH2) in the duplicated area with respect to cell A as “*(0,1,0)”.

Incidentally, the table layout examples shown in FIGS. 6 and 7 are only examples; if the load degree information and the cell duplication information can be managed in the data storage (150), any available method may be employed to manage the load degree information and the cell duplication information.

The channel allocation calculation module (151) determines a radio channel to be allocated to each cell on the basis of data managed by the data storage (150) and shown in FIGS. 6 and 7.

### (Load Distribution Method)

Next, referring to FIG. 8, description will be given of a sequence of processing steps of the load distribution method in the embodiment.

First, the load degree measuring module (11) observes, on the basis of information acquired from each wireless base station (AP), the load state of a cell configured by each wireless base station (AP) to measure an allocation state of each radio channel used in the cell configured by each wireless base station (AP) and the load state of the radio channel (step S0).

Next, the measuring module (11) inputs, to the load degree input module (12), information (load degree information) regarding the allocation state of each radio channel used in the cell configured by each wireless base station (AP) and the load state of the radio channel.

In this connection, it is favorable that the load degree measuring module (11) observes, periodically or after conducting channel allocation for each wireless base station (AP), the load state of the cell constructed by each wireless base station (AP) to measure the allocation state of the radio channel of each cell and the load state of the radio channel.

The load degree input module (12) stores, in the data storage (150) of the channel allocation determination module (15), the information (load degree information) regarding the allocation state of the radio channel of each cell and the load state of the radio channel inputted from the load degree measuring module (11).

As a result, the data storage (150) manages data as shown in FIG. 6.

Additionally, the cell duplication measuring module (13) measures, on the basis of information obtained from each wireless base station (AP), information (cell duplication information) regarding the duplication state between cells configured by each wireless base station (AP), a cell to which a wireless terminal (STA) existing in a shared cover area (duplicated area) between the cells belongs, and a radio channel to be used by the wireless terminal (STA) and the load degree of the radio channel (step S0).

Next, the cell duplication measuring module (13) inputs the measured cell duplication information to the cell duplication information input module (14).

The input module (14) stores in the data storage (150) of the channel allocation determination module (15) the cell duplication information inputted from the measuring module (13).

As a result, the data storage (150) manages data as shown in FIG. 7.

Next, the channel allocation calculation module (151) determines, on the basis of data managed by the data storage (150) as shown in FIGS. 6 and 7, whether or not there exists a cell using a plurality of channels; if it is determined that there exists a cell using a plurality of channels, the calculation module (151) determines whether or not it is possible to discard the used channels.

Resultantly, the channel allocation calculation module (151) determines whether or not there exists a cell which is using a plurality of channels and which is a channel discard object (step S11).

The calculation module (151) makes a search, if it is determined that there exists a cell which is using a plurality of channels and which is a channel discard object (yes in step S11), through cells using the largest number of channels to retrieve a cell with the lowest total load (step S12).

Incidentally, if there exist a plurality of cells using the largest number of channels, the calculation module (151) retrieves a cell with a lowest total load degree from cells of which the total load degree takes a minimum value. Assume that the cell with the lowest total load degree retrieved through the retrieval processing in this step S12 is cell D.

Next, the channel allocation calculation module (151) determines whether or not there exists a discardable radio channel in cell D with the lowest total load degree retrieved through the retrieval processing in this step S12.

In this connection, the discardable radio channel indicates a radio channel which can be discarded without causing an overload state in the other radio channels being used in the cell D.

The channel allocation calculation module (151) selects, if it is determined that a discardable radio channel exists in cell D (yes in step S13), a radio channel from the discardable radio channels in cell D, the radio channel leading to the maximum reduction effect for the total load degree of each cell if the radio channel is discarded. Thereafter, the calculation module (151) instructs the channel allocation control module (16) to discard the selected radio channel (step S14).

As a result, the channel allocation control module (16) conducts a control operation to discard a radio channel indicated by the channel allocation calculation module (151), the radio channel being selected from a plurality of radio channels allocated in cell D.

In this regard, after conducting the control operation, the load resource apparatus (1) again observes the load state of each cell by the load degree measuring module (11) and the cell duplication measuring module (13; step S0).

Also, the channel allocation calculation module (151) determines, if it is determined that there does not exist a discardable radio channel in cell D (no in step S13), that cell D is determined as a cell being other than a channel discard object cell (step S15) and goes to step S11.

Thereafter, the calculation module (151) again determines whether or not there exists a channel discard object cell using a plurality of channels (step S11) to make a check for a subsequent discard object cell.

Also, the calculation module (151) determines, if it is determined in step S11 that there does not exist a channel discard object cell using a plurality of channels (no in step S11), whether or not there exists a reinforcement object cell in an overload state (step S21).

In this connection, for a cell using a plurality of channels, the channel allocation calculation module (151) does not determine that the cell is a reinforcement object cell in an overload state if the overload state in the cell can be removed when the load state of the radio channels is adjusted by use of the plural channels being used in the cell.

Subsequently, the calculation module (151) makes a search, if it is determined that there exists a reinforcement object cell in an overload state (yes in step S21), through the reinforcement object cells in an overload state to retrieve a cell with a most serious overload state (a cell with the highest load degree) to regard the retrieved cell as a channel allocation object cell (step S22).

As a result, the channel allocation calculation module (151) can retrieve, from the cells for which channel adjustment has been conducted in the cells, a most serious overload state cell with the most serious load state. Incidentally, assume that the most serious overload state cell retrieved through the retrieval processing by the calculation module (151) is cell A.

Next, the calculation module (151) determines whether or not a free channel exists in the vicinity of the channel allocation object cell A (step S23). Incidentally, a free channel is a radio channel not being used by an adjacent cell adjacent to cell A.

The calculation module (151) issues, if it is determined that a free channel exists in the vicinity of the channel allocation object cell A (yes in step S23), an indication to the channel allocation control module (16) to add the free channel to cell A (step S24).

As a result, the control module (16) carries out a control operation to add the free channel indicated by the calculation module (151) to cell A.

In this connection, after conducting the control operation, the load source apparatus (1) again observes the load state of each cell by the load degree measuring module (11) and the cell duplication measuring module (13; step S0).

Additionally, the channel allocation calculation module (151) determines, if it is determined that a free channel does not exist in the vicinity of the channel allocation object cell A (no in step S23), whether or not there exists a radio channel which is not being used by cell A and which is being used by the adjacent cell (step S25).

The calculation module (151) assumes, if it is determined that there does not exist a radio channel which is not being used by cell A and which is being used by the adjacent cell (no in step S25), that there does not exist a radio channel to be allocated to cell A to determine that cell A is a cell other than the reinforcement object cell (step S26) and goes to step S21.

Thereafter, the channel allocation calculation module (151) again determines whether or not there exists a reinforcement object cell in the overload state (step S21) to make a check for a subsequent reinforcement object cell.

Also, the calculation module (151) determines, if it is determined that there exists a radio channel which is not being used by cell A and which is being used by the adjacent cell (yes in step S25), whether or not there exists a shared channel to be shared with cell A in the radio channels which are not being used by cell A and which are being used by the adjacent cell (step S31).

In this regard, as the determination criterion to determine whether or not there exists a shared channel, there is favorably employed a condition in which when cell A and the adjacent cell share the radio channel, the overload state of cell A is removed and the adjacent cell does not enter an overload state as a result of the sharing of the radio channel.

The calculation module (151) determines, if the condition above is satisfied, that a shared channel to be shared with cell A exists in the adjacent cell.

Incidentally, the channel allocation calculation module (151) selects, if it is determined that a shared channel to be shared with cell A exists in the adjacent cell (yes in step S31), a radio channel from the radio channels satisfying the above condition, the radio channel leading to a minimum value of the total load degree increase in the respective cells when the radio channel is shared, and sets the selected channel as a shared channel to be shared with cell A.

Incidentally, if there exist a plurality of radio channels for which the total load degree increase takes a minimum value, the calculation module (151) issues an indication to the channel allocation control module (16) to select a radio channel for which the load state before the sharing of the radio channel with cell A takes a minimum value to set the selected radio channel as a shared channel to be shared with cell A (step S32).

Resultantly, the channel allocation control module (16) carries out a control operation to share with cell A the shared channel indicated by the channel allocation calculation module (151).

In this connection, after conducting the control operation, the load source apparatus (1) again observes the load state of each cell by the load degree measuring module (11) and the cell duplication measuring module (13; step S0).

Additionally, the calculation module (151) determines, if it is determined that a shared channel to be shared with cell A does not exist in the adjacent cell (no in step S31), whether or not there exists an adjacent cell which includes an exclusive channel exclusively using a radio channel not being used by cell A and which has a free channel in a periphery thereof (step S41).

Particularly, in a situation wherein there exists a free channel in a periphery of the adjacent cell, even if the adjacent cell conducts a changeover to the free channel, no influence is exerted upon a cell in the periphery of the adjacent cell. Hence, it is possible to control such that the adjacent cell is changed to a free channel and the exclusive channel is transferred to cell A. In this connection, assume that the adjacent cell which can transfer an exclusive channel to cell A is cell B.

The channel allocation calculation module (151) issues, if it is determined that there exists the adjacent cell B which includes an exclusive channel exclusively using a radio channel not being used by cell A and which has a free channel in a periphery thereof (yes in step S41), an indication to the channel allocation control module (16) to replace the exclusive channel of the adjacent cell B by a free channel and to transfer the exclusive channel of the adjacent cell B to cell A (step S42).

As a result, the control module (16) conducts a control operation for the adjacent cell B to replace the exclusive channel of the adjacent cell B by a free channel and to transfer the exclusive channel of the adjacent cell B to cell A.

Hence, the adjacent cell B conducts changeover control to a free channel existing in a periphery of the adjacent cell B itself and transfers the exclusive channel which the adjacent cell B is being exclusively used to cell A.

In this regard, after conducting the control operation, the load source apparatus (1) again observes the load state of each cell by the load degree measuring module (11) and the cell duplication measuring module (13; step S0).

In addition, the channel allocation calculation module (151) determines, if it is determined that there does not exist the adjacent cell B which includes an exclusive channel and which has a free channel in its periphery (no in step 41), whether or not there exists an adjacent cell including an exclusive channel, the adjacent cell being as follows: even if the exclusive channel is transferred to cell A, the exclusive channel is replaceable by sharing a radio channel being used by a peripheral cell existing in its periphery and there does not exist a radio channel in an overload state as well as there does not either exist a radio channel in an overload state also in the peripheral cell sharing the radio channel (step S43).

Particularly, even in a situation wherein a free channel does not exist in the periphery of the adjacent cell itself, by sharing a radio channel with a peripheral cell existing in the periphery of the adjacent cell, if an overload state does not take place in the adjacent cell and the peripheral cell, it is possible to share the radio channel and to transfer the exclusive channel to cell A. Incidentally, assume that the adjacent cell which can transfer the exclusive cell by sharing a radio channel is cell C.

The channel allocation calculation module (151) issues, if it is determined that there exists an adjacent cell C capable of transferring the exclusive channel by sharing a radio channel (yes in step S43), an indication to the channel allocation control module (16) such that adjacent cell C shares a radio channel and transfers the exclusive channel thereof to cell A (step S44).

As a result, the control module (16) carries out a control operation for the adjacent cell C to share a radio channel and to transfer the exclusive channel thereof to cell A.

Consequently, the adjacent cell C conducts changeover control to share a radio channel with a peripheral cell existing in a periphery thereof and transfers the exclusive channel being exclusively used by the adjacent cell C to cell A.

In this regard, after conducting the control operation, the load source apparatus (1) again observes the load state of each cell by the load degree measuring module (11) and the cell duplication measuring module (13; step S0).

Incidentally, the calculation module (151) determines, if it is determined that there does not exist an adjacent cell C capable of transferring the exclusive channel by sharing a radio channel (no in step S43), that cell A is a cell other than the reinforcement object cell (step S26) and goes to step S21.

Thereafter, the channel allocation calculation module (151) again determines whether or not there exists a reinforcement object cell in the overload state (step S21) to make a check for a subsequent reinforcement object cell.

### (Load Distribution Method of Embodiment A)

Next, description will be given of a sequence of control operations in a case to which a load distribution method shown in FIG. 8 is applied on the basis of the cell structure and the use state and the load state of radio channels of each cell shown in FIG. 3.

Incidentally, when the load distribution method shown in FIG. 8 is employed on the basis of the cell structure and the use state and the load state of radio channels of each cell shown in FIG. 3, the graph notation shown in FIG. 9 is introduced in the embodiment.

In the graph notation shown in FIG. 9, a cell constructed by each wireless base station (AP) is referred to as a node.

As shown in FIG. 9, if the respective nodes are in an adjacent state (a shared cover area exists between the adjacent nodes), a line (branch) is drawn therebetween. Furthermore, if there exists a shared channel for which a radio channel is shared between the adjacent nodes, two parallel branches are drawn.

Also, as shown in FIG. 9, for each node, there are described a number of each radio channel being used by the node and a load degree (corresponding to the value of FIG. 6) in consideration of influence from the adjacent node. Moreover, for a branch, there are described for each node a load degree (corresponding to the value of FIG. 7) of each channel in the shared cover area in a radio channel number sequence.

In this connection, the graph notation shown in FIG. 9 is created on the basis of load degree information (data shown in FIG. 6) and cell duplication information (data shown in FIG. 7) stored in the data storage (150).

Incidentally, to simplify explanation, it is assumed in the embodiment that when a shared channel exists between the adjacent nodes and if the shared channel causes a load degree to take place in a shared cover area between the adjacent nodes, the load degree is added to each of the nodes.

That is, in the embodiment, as for the load degrees of the respective radio channels in the shared cover area, if the load degree is associated with a shared channel, the load degree is added to both nodes.

For example, in FIG. 9, in a shared cover area between the adjacent nodes of cells D and E, there occurs load degree “1” of radio channel CH2 as “E:(0,1,0)”.

In this case, load degree “1” is added to radio channel CH2 of cell D as “D2-2(1+1: 1 indicates a load degree in the cover area)”. Also, load degree “1” is added to radio channel CH2 of cell E as “E2-3(2+1: 1 indicates a load degree in the cover area)”.

Moreover, assume in the embodiment that there exist three available channels (CH1,CH2,CH3). Furthermore, assume that a state with a load degree equal to or more than ten is an overload state.

Next, referring to FIGS. 8 to 10, description will be given of a load distribution method in embodiment A.

First, the channel allocation calculation module (151) determines whether or not channel discard is possible for a node which is using a plurality of channels (step S11). Incidentally, only node D is the object in the embodiment.

In this regard, since two radio channels being used in node D have load degrees “6(CH1)” and “2(CH2)” and the total load degree is eight, the overload state does not take place even if one radio channel is discarded.

Incidentally, when node D discards CH1, since nodes C and E which are adjacent to node D are not using CH1, the load state of the other nodes is not mitigated even if CH1 is discarded, and the load degree “2” of CH1 of node D is transferred to CH2.

Hence, when node D discards CH1, the load state of node E using CH2 is increased (in the embodiment, since the node D belonging load degree of CH1 on the branch between nodes D and E is “1” as “D:(1,0,0)”, when CH1 of node D is discarded and a transfer takes place to CH2, the node D belonging load degree of CH1 “1” is transferred to the node D belonging load degree of CH2 “1” as “D:(0,1,0)”, and one is added to the load degree of CH2 of node E as “E2-3”→“E2-4(3+1)”.

In addition, when node D discards CH2, the node D belonging load degree of CH2 “1” on the branch between nodes C and D, namely, “D:(0,1,0)” is transferred to the node D belonging load degree of CH1 “D:(1,0,0)”; however, since node C is not using CH1, node C is not influenced from the discard of CH2 by node D.

In addition, since there does not exist a node D belonging load degree of CH2 on the branch between nodes D and E as “D:(1,0,0)”, node E is not influenced from the discard of CH2 by node D. Hence, in the embodiment, CH2 is selected as the discard channel of node D (step S14).

Incidentally, of the load degree “2” of CH2 of node D, the load degree “1” is due to the node E belonging load degree on the branch between nodes D and E as “E:(0,1,0)”; therefore, as a result of the discard of CH2 by node D, only a load degree “1” is transferred to CH1 of node D; hence, the load degree of CH1 of node D becomes seven.

In this connection, FIG. 10(b) “after execution of channel recall” shows the graph notation between the respective cells after execution of the channel recall described above.

In the state of FIG. 10(a) “before execution”, when the channel recall is executed, node D discards channel CH2 and the load degree of channel CH1 of node D becomes seven.

Additionally, the node D belonging load degree “D:(0,1,0)” of CH2 on the branch between nodes C and D is transferred to the node D belonging load degree of CH1 as “D:(1,0,0)”, leading to the state of FIG. 10(b) “after execution of channel recall”.

Next, control goes to an overload state removing stage (step S21).

Incidentally, as shown in FIG. 9, only node A is a node in the overload state in the embodiment.

Nodes B, C, and E are adjacent nodes of node A; node B uses CH2, node C uses CH3, and node E uses CH2. That is, no free channel exists in the periphery of node A (no in step S23).

Hence, it is required for node A to share CH2 or CH3 with an adjacent node (yes in step S25).

First, when CH2 is used as a shared channel, from the load degree “11” of CH1 of node A, the smallest load degree “2” is transferred to CH2.

In this situation, although nodes B and E are using CH2, if the load degree of node A for other than CH1 on the branch between node A and B and the load degree of node A for other than CH1 on the branch between node A and E are transferred to CH2, nodes B and E are not influenced.

However, the node B belonging load degree “B:(0,1,0)” of CH2 on the branch between nodes A and B and the node E belonging load degree “B:(0,1,0)” of CH2 on the branch between nodes A and E are also associated with the load of CH2 of node A; hence, if CH2 is a shared channel, the load degree of CH1 of node A becomes 9(11−2) and that of CH2 of node A becomes 4(2+2: 2 indicates a load degree in the cover area).

Also, if CH3 is a shared channel, node B and node E are not influenced. Although node C is using CH3, as for the load degree “2” to be transferred from CH1 of node A to CH3, if the load degree of node A other than CH1 on the branch between nodes A and C is transferred to CH3, node C is not influenced. Moreover, since there does not exist a node C belonging load degree on the branch between nodes A and C as “C:(0,0,0)”, even if CH3 is employed as a shared channel, node A is not influenced from the node C belonging load degree.

Hence, when CH3 is used as a shared channel, the load degree of CH1 of node A is 9(11−2) and that of CH3 of node A becomes 2(2+0: 0 indicates the load degree in the cover area).

Therefore, when CH2 is used as a shared channel, the total load degree increase of each node is two; whereas, when CH3 is used as a shared channel, the total load degree increase of each node is zero. Hence, CH3 will be shared with node A. This makes it possible to remove the overload state of node A.

In this connection, FIG. 10(c) “after channel sharing” shows a graph notation between the respective cells after the channel sharing is executed.

In the state of FIG. 10(b) “after execution of channel recall”, when the channel sharing is carried out, nodes A and C share channel CH3; the load degree of CH1 of node A becomes nine and that of CH3 is two, which establishes the state of FIG. 10(c) “after channel sharing”.

### (Load Distribution Method of Embodiment B)

Next, description will be given of embodiment B.

In the cell structure and the utilization state and the load state of radio channels shown in FIG. 11(a), it is assumed as in embodiment A described above that the number of available channels is three in total (CH1,CH2,CH3). It is additionally assumed that a state with the load degree equal to or more than ten is an overload state. Incidentally, in embodiment B, node A has a load degree of 17 and is in an overload state.

First, in the periphery of node A, since node B is using CH2 and node C is using CH3, it is determined that no free channel exists in the periphery of node A (no in step S23).

If node A shares CH2 with node B, by retaining the largest load degree “9” on CH2, the rest of load degree “8” will be transferred to CH2; however, since there exists the node B belonging load degree “2” for CH2 on the branch between nodes A and B as “B:(0,2,0)”, the load degree “2” is added to the load degree “8” of CH2 in node A and the load degree of CH2 in node A becomes ten in total; it is hence not possible to remove the overload state of node A (after the channel CH2 sharing shown in FIG. 11(b)).

Furthermore, if node A shares CH3 with node C, by retaining the largest load degree “9” on CH1, the rest of load degree “8” will be transferred to CH3; however, since there exists the node C belonging load degree “2” for CH3 on the branch between nodes A and C as “C:(0,0,2)”, the load degree “2” is added to the load degree “8” of CH3 in node A and the load degree of CH3 in node A becomes ten in total; it is hence not possible to remove the overload state of node A (after the channel CH3 sharing shown in FIG. 11(c)).

Therefore, according to the load distribution method shown in FIG. 8, the existence of a shared channel in step S31 is “No” and control goes to step S41.

Incidentally, each of nodes B and C which are adjacent nodes of node A includes an exclusive channel, and there exists a free channel in the periphery of each thereof.

For example, CH3 is a free channel for node B; the channel being used by node B is changed from CH2 to CH3 and the exclusive channel CH2 can be transferred to node A.

Resultantly, node A can exclusively use CH1 and CH2 to remove the overload state (after the channel reallocation shown in FIG. 11(d)).

In addition, CH2 is a free channel for node C; the channel being used by node C is changed from CH3 to CH2 and the exclusive channel CH3 can be transferred to node A.

As a result, node A can exclusively use CH1 and CH3 to remove the overload state (after the channel reallocation shown in FIG. 11(e)).

Incidentally, in a situation as the embodiment wherein there exist a plurality of nodes each including an exclusive channel and each having a free channel in the periphery thereof, it is favorable that a node of which the exclusive channel to be transferred to cell A has the smallest load degree is selected and then exclusive channel changeover control is conducted for the selected node to transfer the exclusive channel to node A.

Hence, in the embodiment, node B of which the exclusive channel has the smallest load degree is selected and changeover control of the exclusive channel CH2 is made to be executed for the selected node B to transfer the exclusive channel CH2 to node A. That is, the channel reallocation shown in FIG. 11(d) is carried out.

As above, the load distribution apparatus (1) of the embodiment acquires the radio channel allocation state of each of the wireless base stations (cells A to E). Thereafter, on the basis of the obtained allocation state, the apparatus (1) detects an overload wireless base station (cell A) which is using an overload radio channel in an overload state (a radio channel with a load degree of, for example, ten or more). Then, on the basis of the obtained allocation state, the apparatus (1) allocates a new radio channel (e.g., CH2) to the overload wireless base station (cell A) to conduct load distribution for an overload radio channel (a radio channel with a load degree of, for example, ten or more: CH1).

Due to the operation, at detection of an overload radio channel in an overload state (CH1 of cell A) in the wireless base stations (cells A to E), the load distribution apparatus (1) can lower the load on the overload radio channel (CH1 of cell A) in consideration of the radio channel allocation states of the adjacent wireless base stations (cells B to E) adjacent to the wireless base station (cell A).

Furthermore, the load distribution apparatus (1) of the embodiment detects, on the basis of the allocation states of the respective wireless base stations (cells A to E), a wireless base station (e.g., cell D) which does not cause an overload radio channel (a radio channel with a load degree of, for example, ten or more) to exist when a radio channel being used by a wireless base station (cells A to E) is discarded and then conducts control such that the detected wireless base station (cell D) discards the radio channel (e.g., CH2).

Resultantly, the load distribution apparatus (1) can discard the channel (CH2) being used by the wireless base station (e.g., cell D) which does not cause an overload radio channel (a radio channel with a load degree of, for example, ten or more) to exist, and set an environment state in which radio channel allocation control can be continuously carried out.

### Second Exemplary Embodiment

Next, description will be given of a second exemplary embodiment.

The wireless communication system in the first exemplary embodiment includes as shown in FIG. 1 the load distribution apparatus (1) to control the respective wireless base stations (AP); the apparatus (1) measures, on the basis of information attained from the respective wireless base stations (AP), load degree information of each radio channel for each cell and information (cell duplication information) of duplicated areas between the respective cells and stores the measured data in the data storage (150) and manages the data. Also, the apparatus (1) carries out the load distribution method shown in FIG. 8 on the basis of data stored and managed in the data storage (150).

The wireless communication system in the second exemplary embodiment is constructed by installing the function of the load distribution apparatus (1) in the wireless base station (AP) and including as shown in FIG. 12 wireless base stations (AP) and wireless terminals (STA). Moreover, the system is characterized in that the load distribution method shown in FIG. 8 is conducted in the wireless base stations (AP).

Therefore, when a radio channel in an overload state is detected in the radio channels being used in one of the wireless base stations (AP), the base station (AP) itself can execute the load distribution processing to conduct load distribution for the radio channel in an overload state. Subsequently, referring to FIG. 12, description will be given of the wireless communication system in the second exemplary embodiment.

### System Configuration of Wireless Communication System

First, referring to FIG. 12, description will be given of the wireless communication system in the second exemplary embodiment.

The wireless communication system of the second exemplary embodiment includes wireless base stations (AP) and wireless terminals (STA) as shown in FIG. 12.

In this connection, the wireless base station (AP) is configured to include the function of the load distribution apparatus (1) of the first exemplary embodiment to conduct the load distribution control shown in FIG. 8.

In this case, it is favorable that a wireless base station (AP1) is determined as a master to conduct the load distribution control shown in FIG. 8 among the wireless base stations such that the master wireless base station (AP1) obtains, from the respective wireless base stations (AP), the information necessary to measure the load degree information of each radio channel for each cell and the information (cell duplication information) of duplicated areas between the respective cells to carry out the load distribution control shown in FIG. 8 on the basis of the obtained information.

Therefore, the wireless base station (AP1) as the master can carry out load distribution control similar to that of the load distribution apparatus (1) of the first exemplary embodiment described above.

In this regard, the method of determining the wireless base station (AP1) to serve as the master is not particularly limited, but for example, a wireless base station with the smallest MAC address of the installed network interface or a wireless base station connected to a wired network can be determined as the master wireless base station (AP1). That is, any methods are available to determine the wireless base station (AP1) to serve as the master.

In this fashion, the wireless base station (AP1) of the embodiment obtains the radio channel allocation states of the respective wireless base stations (cells A to E) in almost the same way as for the load distribution apparatus (1) of the first exemplary embodiment described above. Then, the base station (AP1) detects, on the basis of the obtained allocation states, an overload wireless base station (cell A) which is using an overload radio channel in an overload state (a radio channel with a load degree of, for example, ten or more). Furthermore, on the basis of the obtained allocation states, the base station (AP1) allocates a new radio channel (e.g., CH2) to the overload wireless base station (cell A) to conduct load distribution for an overload radio channel (a radio channel with a load degree of, for example, ten or more: CH1).

As a result, at detection of an overload radio channel in an overload state (CH1 of cell A) in the wireless base stations (cells A to E), the wireless base station (AP) can reduce the load on the overload radio channel (CH1 of cell A) in consideration of the radio channel allocation states of the adjacent wireless base stations (cells B to E) adjacent to the wireless base station (cell A).

Additionally, like the load distribution apparatus (1) of the first exemplary embodiment described above, the wireless base station (AP) of the embodiment detects, on the basis of the allocation states of the respective wireless base stations (cells A to E), a wireless base station (e.g., cell D) which does not cause an overload radio channel (a radio channel with a load degree of, for example, ten or more) to exist when a radio channel being used by a wireless base station (cells A to E) is discarded, and then conducts control such that the detected wireless base station (cell D) discards the radio channel (e.g., CH2).

As a result, the wireless base station (AP) can discard the channel (CH2) being used by the wireless base station (e.g., cell D) which does not cause an overload radio channel (a radio channel with a load degree of, for example, ten or more) to exist, and establish an environment state in which radio channel allocation control can be continuously carried out.

Moreover, the wireless communication system shown in FIG. 12 may also be constructed such that each wireless base station (AP) includes a function similar to that of the load distribution apparatus (1) of the first exemplary embodiment, and the load degree information and the cell duplication information are communicated between the respective wireless base stations (AP); when one of the wireless base stations (AP) determines that a radio channel being used by the wireless base station (AP) is in an overload state, the wireless base station (AP) autonomously conducts load distribution control similar to that shown in FIG. 8, to thereby conduct load distribution for the radio channel in the overload state.

In the configuration described above, the wireless base station (AP) obtains the radio channel allocation states of the adjacent wireless base stations adjacent to the wireless base station (AP). Furthermore, at detection of an overload radio channel in an overload state in the radio channels being used by the wireless base station (AP), the wireless base station (AP) can allocate, on the basis of the obtained allocation states, a new radio channel to the overload radio channel to conduct load distribution for the overload radio channel.

Hence, the wireless base station (AP) can reduce the load of the overload radio channel in consideration of the radio channel allocation states of the adjacent wireless base station adjacent to the wireless base station (AP).

In addition, the wireless base station (AP) can detect a radio channel which does not cause an overload radio channel to exist when a radio channel being used by the wireless base station is discarded and discard the detected radio channel.

Incidentally, the embodiments described above are favorable embodiments of the present invention, but the range of the invention is not limited only to these embodiments; the embodiments may be modified and/or substituted to be changed in various ways by those skilled in the art without departing from the spirit and scope of the present invention.

For example, in the first exemplary embodiment described above, the load degree measuring module (11) and the cell duplication measuring module (13) are mounted in the load distribution apparatus (1); however, the measuring modules (11) and (13) can be arranged outside the load distribution apparatus (1).

In this case, the load degree measuring module (11) measures the load degree information of each radio channel for each cell on the basis of the information acquired from the respective wireless base stations (AP) and transmits the load degree measured information to the load distribution apparatus (1).

Furthermore, the cell duplication measuring module (13) measures the information (cell duplication information) of duplicated areas between the respective cells on the basis of the information acquired from the respective wireless base stations (AP) and transmits the measured duplication information to the load distribution apparatus (1).

Therefore, the load distribution apparatus (1) can store the information items sent from the measuring modules (11) and (13) in the data storage (150) of the apparatus (1) to manage the data shown in FIGS. 6 and 7 in the storage (150) of the apparatus (1).

It is also possible to construct the system such that the functions corresponding to the load degree measuring module (11) and the cell duplication measuring module (13) are installed in each wireless base station (AP), the load degree information and the cell duplication information are measured by each wireless base station (AP), the measured information items are sent to the load distribution apparatus (1), and the data shown in FIGS. 6 and 7 is managed by the data storage (150) of the load distribution apparatus (1).

Additionally, the system may also be configured such that the function corresponding to the cell duplication measuring module (13) is installed in the wireless terminal (STA); in a situation wherein the terminal (STA) determines that strong wireless signals from a plurality of wireless base stations (AP) has been detected, the terminal (STA) determines that the terminal (STA) exists in a duplicated area of a plurality of cells and transmits information indicating that the terminal (STA) exists in the duplicated area, via a wireless base station (AP) to which the terminal (STA) belongs, to the load distribution apparatus (1).

Any system configuration may be constructed if the load distribution apparatus (1) can acquire the data shown in FIGS. 6 and 7 to manage the acquired data as shown in FIGS. 6 and 7 by use of the data storage (150) of the load distribution apparatus (1) as above.

In addition, the load distribution apparatus (1) or the wireless base station (AP) executes a sequence of processing shown in FIG. 8 in the embodiments; however, the system may also be constructed to achieve in the apparatus (1) or the station (AP) at least one of the control methods including the control method of FIG. 2(a) “channel addition (when a free channel exists in the periphery)”, the control method of FIG. 2(b) “channel sharing (when a free channel does not exist in the periphery)”, and the control method of FIG. 2(c) “channel reallocation (when a free channel does not exist in the periphery)”.

In this connection, when the system is constructed such that at least one of the control methods are carried out in the load distribution apparatus (1) or the wireless base station (AP), it is favorable to construct the system such that when it is determined that there exists an unused radio channel in an adjacent wireless base station (corresponding to cell B) adjacent to the wireless base station (corresponding to cell A), the control method of FIG. 2(a) “channel addition (when a free channel exists in the periphery)” is conducted, for example, as shown in FIG. 2.

Furthermore, if it is determined that there does not exist an unused radio channel in the adjacent wireless base station (corresponding to cell B) adjacent to the wireless base station (corresponding to cell A), it is favorable to conduct the control method of FIG. 2(b) “channel sharing (when a free channel does not exist in the periphery)”, or the control method of FIG. 2(c) “channel reallocation (when a free channel does not exist in the periphery)”.

Furthermore, the system is favorably constructed such that if it is determined that there exists an overload radio channel in an overload state in an adjacent wireless base station (corresponding to cell B) adjacent to a wireless base station (corresponding to cell A), the control method of FIG. 2(c) “channel reallocation (when a free channel does not exist in the periphery)” is conducted.

Also, the system may be constructed such that since the maximum range of radio channels vary between wireless systems or between countries, the range of radio channels is arbitrarily set and is arbitrarily changed according to the country to execute the processing described above within the range of radio channels.

Moreover, the control operations of wireless apparatuses such as the load distribution apparatus (1) and the wireless base station (AP) configuring the wireless communication system of the embodiments described above may be carried out by hardware, software, or a composite configuration of hardware and software.

Incidentally, if the processing is executed by software, a program having recorded a processing sequence can be installed in a memory of a computer incorporated in a dedicated hardware and executed or the program can be installed in a general computer which can execute various processing and executed.

For example, the program may be beforehand recorded in a hard disk or a Read Only Memory (ROM) as a recording medium. Or, the program may be temporarily or permanently stored (recorded) in removable recording media such as a floppy disk (registered trademark), a Compact Disc Read Only Memory (CD-ROM), a Magneto optical (MO) disk, a magnetic disk, and a semiconductor memory.

Such removable recording media may be provided as so-called package software.

Incidentally, in addition to the installation from the removable recording media into a computer, the program can be wirelessly transferred from a download site to a computer or transferred via networks such as a Local Area Network (LAN) and the internet to a computer through a wired path; and the computer can receive the transferred program and install the program in a recording medium such as a hard disk incorporated therein.

Furthermore, the system may also be constructed such that the program is executed not only in time-series fashion according to the processing operation described in the embodiments, but the program may be executed in a concurrent fashion or individually according to processing capacity of the apparatus which executes the processing or according to necessity.

In addition, the wireless communication system described in the embodiments may also be constructed in a configuration including logical sets of a plurality of apparatuses or in a configuration including functions of the respective apparatuses.

According to the description of the embodiments above, the embodiments have features as below.

The wireless base station in the embodiment is a wireless base station capable of allocating a plurality of radio channels to be used for wireless communication, characterized by comprising:

allocation state acquiring means for acquiring allocation states of radio channels of adjacent wireless base stations adjacent to the wireless base station;

load detecting means for detecting an overload radio channel in an overload state in radio channels being used by the wireless base station; and

load distributing means for allocating a new radio channel on the basis of the allocation states acquired by the allocation state acquiring means and conducting load distribution for the overload radio channel.

Furthermore, in the wireless base station of the embodiment, it is characterized that:

the load distributing means comprises at least one of allocating means including:

first allocating means for allocating, as a new radio channel, a radio channel not being used in the adjacent wireless base station;

second allocating means for allocating, as a new radio channel, a radio channel being used in the adjacent wireless base station; and

third allocating means for allocating, as a new radio channel, an exclusive radio channel which is a radio channel not being used in the wireless base station and which is being exclusively used in the adjacent wireless base station.

Also, in the wireless base station of the embodiment, it is characterized that:

the third allocating means controls such that the adjacent wireless base station is changed over to a new radio channel and the exclusive channel of the adjacent wireless base station is transferred to the wireless base station, to thereby allocate the exclusive channel as a new radio channel.

Moreover, in the wireless base station of the embodiment, it is characterized that:

the load distributing means allocates, on the basis of the allocation states, the new radio channel by the first allocating means if there exists a radio channel not being used in the adjacent wireless base station.

In addition, in the wireless base station of the embodiment, it is characterized that:

the load distributing means allocates, on the basis of the allocation states, the new radio channel by the second or third allocating means if there does not exist a radio channel not being used in the adjacent wireless base station.

Furthermore, in the wireless base station of the embodiment, it is characterized that:

the load distributing means allocates, on the basis of the allocation states, the new radio channel by the third allocating means if there exists the overload radio channel in the adjacent wireless base station.

Also, in the wireless base station of the embodiment, it is characterized that:

the load distributing means allocates, without causing the overload radio channel to exist in the adjacent wireless base station, the new radio channel by the second or third allocating means.

In addition, in the wireless base station of the embodiment, it is characterized that:

the load distributing means allocates the new radio channel by the third allocating means if it is not possible to allocate the new radio channel by the second allocating means without causing the overload radio channel to exist in the adjacent wireless base station.

Moreover, in the wireless base station of the embodiment, it is characterized that:

the third allocating means comprises

first detecting means for detecting the adjacent wireless base station in which a radio channel exists, the radio channel not being used in a wireless base station in a periphery of the adjacent wireless base station having the exclusive channel.

In addition, in the wireless base station of the embodiment, it is characterized that:

the third allocating means comprises

second detecting means for detecting the adjacent wireless base station which does not cause the overload radio channel to exist in a state wherein the adjacent wireless base station having the exclusive channel and the wireless base station in a periphery of the adjacent wireless base station are sharing a radio channel other than the exclusive channel.

Also, in the wireless base station of the embodiment, it is characterized that:

the third allocating means conducts the detection if it is not possible to detect, by the first detecting means, the adjacent wireless base station in which the radio channel being not used in the peripheral wireless base station exists.

Furthermore, the wireless base station of the embodiments is characterized by comprising:

channel discarding means for detecting, in a state wherein the radio channel being used by the wireless base station is discarded, the radio channel which does not cause the overload radio channel to exist.

Also, the load distribution apparatus of the embodiment is a load distribution apparatus connected to a plurality of wireless base stations capable of allocating a plurality of radio channels to be used for wireless communication for conducting load distribution for a radio channel being used in the wireless base stations, characterized by comprising:

allocation state acquiring means for acquiring allocation states of radio channels of respective wireless base stations;

load detecting means for detecting an overload wireless base station using an overload radio channel in an overload state on the basis of the allocation states acquired by the allocation state acquiring means; and

load distributing means for allocating a new radio channel to the overload wireless base station on the basis of the allocation states acquired by the allocation state acquiring means and conducting load distribution for the overload radio channel.

In addition, in the load distribution apparatus of the embodiment, it is characterized that:

the load distributing means comprises at least one of allocating means including:

first allocating means for allocating a radio channel not being used in the adjacent wireless base station adjacent to the overload wireless base station, as a new radio channel to the overload wireless base station;

second allocating means for allocating a radio channel being used in the adjacent wireless base station, as a new radio channel to the overload wireless base station; and

third allocating means for allocating, an exclusive radio channel which is a radio channel not being used in the overload wireless base station and which is being exclusively used in the adjacent wireless base station, as a new radio channel to the overload wireless base station.

Furthermore, in the load distribution apparatus of the embodiment, it is characterized that:

the third allocating means controls such that the adjacent wireless base station is changed over to a new radio channel and the exclusive channel of the adjacent wireless base station is transferred to the overload wireless base station, to thereby allocate the exclusive channel as a new radio channel to the overload wireless base station.

Also, in the load distribution apparatus of the embodiment, it is characterized that:

the load distributing means allocates, on the basis of the allocation states, the new radio channel to the overload wireless base station by the first allocating means if there exists a radio channel not being used in the adjacent wireless base station.

Additionally, in the load distribution apparatus of the embodiment, it is characterized that:

the load distributing means allocates, on the basis of the allocation states, the new radio channel to the overload wireless base station by the second or third allocating means if there does not exist a radio channel not being used in the adjacent wireless base station.

Furthermore, in the load distribution apparatus of the embodiment, it is characterized that:

the load distributing means allocates, on the basis of the allocation states, the new radio channel to the overload wireless base station by the third allocating means if there exists the overload radio channel in the adjacent wireless base station.

In addition, in the load distribution apparatus of the embodiment, it is characterized that:

the load distributing means allocates, without causing the overload radio channel to exist in the adjacent wireless base station, the new radio channel to the overload wireless base station by the second or third allocating means.

Furthermore, in the load distribution apparatus of the embodiment, it is characterized that:

the load distributing means allocates the new radio channel to the overload wireless base station by the third allocating means if it is not possible to allocate the new radio channel to the overload wireless base station by the second allocating means without causing the overload radio channel to exist in the adjacent wireless base station.

Also, in the load distribution apparatus of the embodiment, it is characterized that:

the third allocating means comprises

first detecting means for detecting the adjacent wireless base station in which a radio channel exists, the radio channel not being used in a wireless base station in a periphery of the adjacent wireless base station having the exclusive channel.

Also, in the load distribution apparatus of the embodiment, it is characterized that:

the third allocating means comprises

second detecting means for detecting the adjacent wireless base station which does not cause the overload radio channel to exist in a state wherein the adjacent wireless base station having the exclusive channel and the wireless base station in a periphery of the adjacent wireless base station are sharing a radio channel other than the exclusive channel.

Additionally, in the load distribution apparatus of the embodiment, it is characterized that:

the third allocating means conducts the detection if it is not possible to detect, by the first detecting means, the adjacent wireless base station in which the radio channel being not used in the peripheral wireless base station exists.

Also, the load distribution apparatus of the embodiment is characterized by comprising:

channel discarding means for detecting on the basis of the allocation states, in a state wherein the radio channel being used by the wireless base station is discarded, a wireless base station which does not cause the overload radio channel to exist and controlling the detected wireless base station to discard the radio channel.

Additionally, the centralized control apparatus of the embodiment is a centralized control apparatus on which the load distribution apparatus described above is mounted, characterized by comprising

wireless base station control means for conducting centralized control of the plural wireless base stations.

Also, the wireless base station of the embodiment is characterized in that:

the load distribution apparatus described above is mounted in the apparatus.

In addition, the wireless communication system of the embodiment is a wireless communication system comprising a plurality of wireless base stations capable of allocating a plurality of radio channels to be used for wireless communication, characterized in that

the wireless base station comprises:

allocation state acquiring means for acquiring allocation states of radio channels of adjacent wireless base stations adjacent to the wireless base station;

load detecting means for detecting an overload radio channel in an overload state in radio channels being used by the wireless base station; and

load distributing means for allocating a new radio channel on the basis of the allocation states acquired by the allocation state acquiring means and conducting load distribution for the overload radio channel.

Furthermore, the wireless communication system of the embodiment is a wireless communication system comprising a plurality of wireless base stations capable of allocating a plurality of radio channels to be used for wireless communication, characterized in that

the wireless base station comprises:

allocation state acquiring means for acquiring allocation states of radio channels of respective wireless base stations;

load detecting means for detecting an overload wireless base station using an overload radio channel in an overload state on the basis of the allocation states acquired by the allocation state acquiring means; and

load distributing means for allocating a new radio channel to the overload wireless base station on the basis of the allocation states acquired by the allocation state acquiring means and conducting load distribution for the overload radio channel.

Additionally, the wireless communication system of the embodiment is a wireless communication system comprising a plurality of wireless base stations capable of allocating a plurality of radio channels to be used for wireless communication and a load distribution apparatus for conducting load distribution for a radio channel being used in the wireless base stations, characterized in that

load distribution apparatus comprises:

allocation state acquiring means for acquiring allocation states of radio channels of respective wireless base stations;

load detecting means for detecting an overload wireless base station using an overload radio channel in an overload state on the basis of the allocation states acquired by the allocation state acquiring means; and

load distributing means for allocating a new radio channel to the overload wireless base station on the basis of the allocation states acquired by the allocation state acquiring means and conducting load distribution for the overload radio channel.

In the wireless communication system of the embodiment, it is characterized that

the load distribution apparatus is a centralized control apparatus for conducting centralized control of the plural wireless base stations.

Also, the load distribution method of the embodiment is a load distribution method for use in a wireless base station capable of allocating a plurality of radio channels to be used for wireless communication, characterized in that the wireless base station carries out:

an allocation state acquiring step for acquiring allocation states of radio channels of adjacent wireless base stations adjacent to the wireless base station;

a load detecting step for detecting an overload radio channel in an overload state in radio channels being used by the wireless base station; and

a load distributing step for allocating a new radio channel on the basis of the allocation states acquired by the allocation state acquiring means and conducting load distribution for the overload radio channel.

Furthermore, the load distribution method of the embodiment is a load distribution method for use with a load distribution apparatus connected to a plurality of wireless base stations capable of allocating a plurality of radio channels to be used for wireless communication for conducting load distribution for a radio channel being used in the wireless base stations, characterized in that the load distribution apparatus carries out:

an allocation state acquiring step for acquiring allocation states of radio channels of respective wireless base stations;

a load detecting step for detecting an overload wireless base station using an overload radio channel in an overload state on the basis of the allocation states acquired by the allocation state acquiring step; and

a load distributing step for allocating a new radio channel to the overload wireless base station on the basis of the allocation states acquired by the allocation state acquiring step and conducting load distribution for the overload radio channel.

In addition, the load distribution program of the embodiment is a load distribution program to be executed in a wireless base station capable of allocating a plurality of radio channels to be used for wireless communication, characterized in that the wireless base station is made to execute:

allocation state acquiring processing for acquiring allocation states of radio channels of adjacent wireless base stations adjacent to the wireless base station;

load detecting processing for detecting an overload radio channel in an overload state in radio channels being used by the wireless base station; and

load distributing processing for allocating a new radio channel on the basis of the allocation states acquired by the allocation state acquiring processing and conducting load distribution for the overload radio channel.

Moreover, the load distribution program of the embodiment is a load distribution program to be executed in a load distribution apparatus connected to a plurality of wireless base stations capable of allocating a plurality of radio channels to be used for wireless communication for conducting load distribution for a radio channel being used in the wireless base stations, characterized in that the load distribution apparatus is made to execute:

allocation state acquiring processing for acquiring allocation states of radio channels of respective wireless base stations;

load detecting processing for detecting an overload wireless base station using an overload radio channel in an overload state on the basis of the allocation states acquired by the allocation state acquiring processing; and

load distributing processing for allocating a new radio channel to the overload wireless base station on the basis of the allocation states acquired by the allocation state acquiring processing and conducting load distribution for the overload radio channel.

### INDUSTRIAL APPLICABILITY

A wireless base station, a load distribution apparatus, a centralized control apparatus, a wireless communication system, a load distribution method, and a load distribution program in accordance with the present invention are suitable to improve the communication quality in wireless communication and to increase the utilization efficiency of radio channels.

### BRIEF DESCRIPTION OF DRAWINGS

FIG. 1 is a diagram showing a system configuration of a wireless communication system in the embodiment.

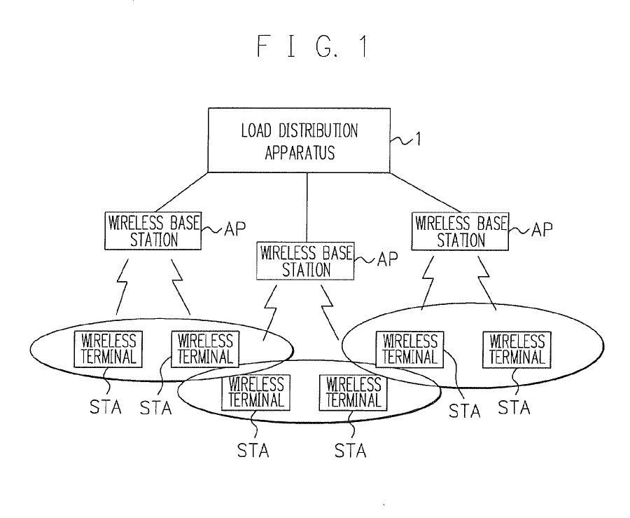

FIG. 2 is a diagram to explain a control method of a load distribution method in the wireless communication system of the embodiment.

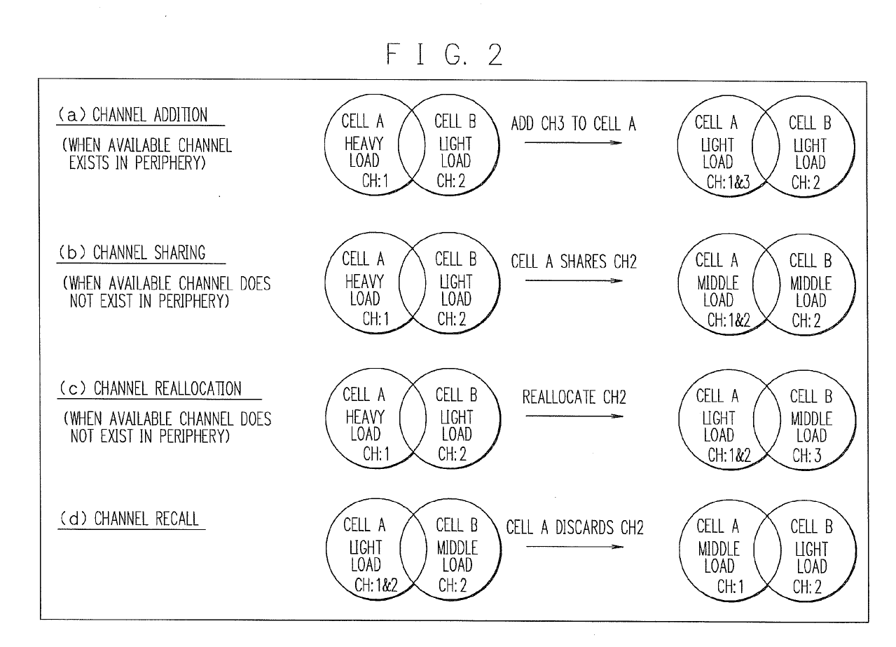

FIG. 3 is a diagram to explain a configuration of cells constructed by the respective wireless base stations (AP) in the embodiment and load states of radio channels to be used in the cells.

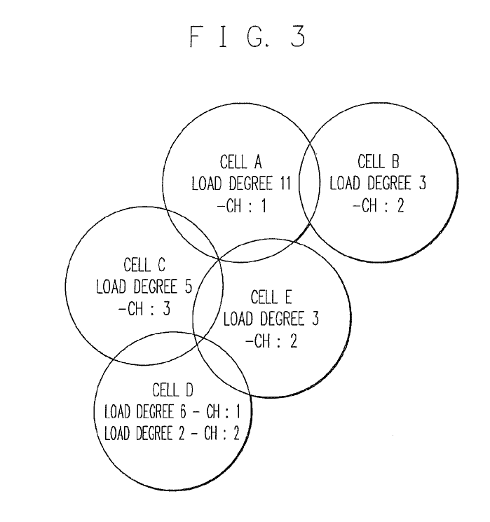

FIG. 4 is a diagram showing an inner configuration of a load distribution apparatus (1) configuring the wireless communication system of the embodiment.

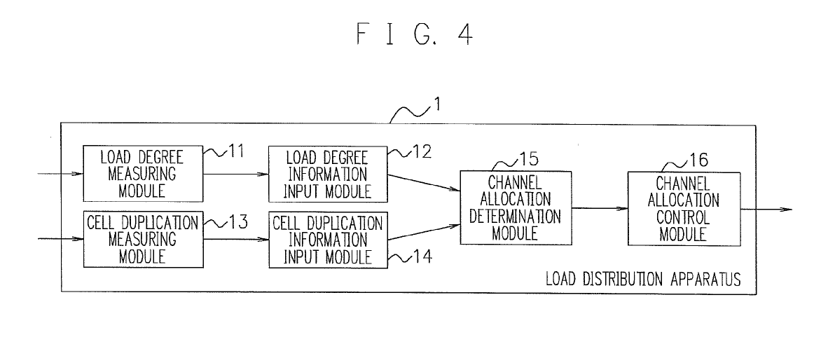

FIG. 5 is a diagram showing an inner configuration of a channel allocation determination module (15) of the load distribution apparatus (1) in the embodiment.

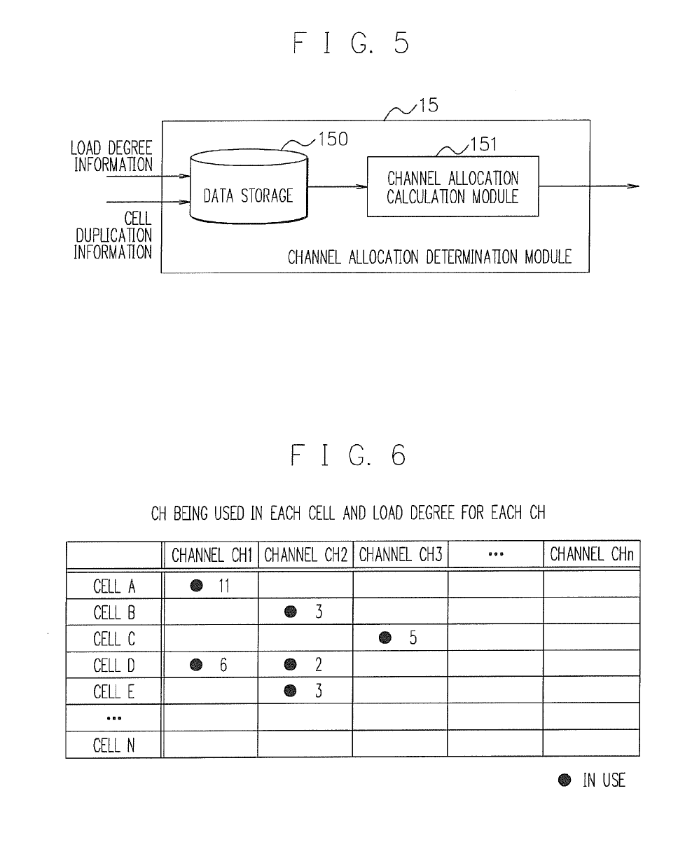

FIG. 6 is a diagram showing a table configuration example of load degree information stored in a data storage (150) and showing used channels of the respective cells in the cell configuration shown in FIG. 3 and load degrees of the used channels.

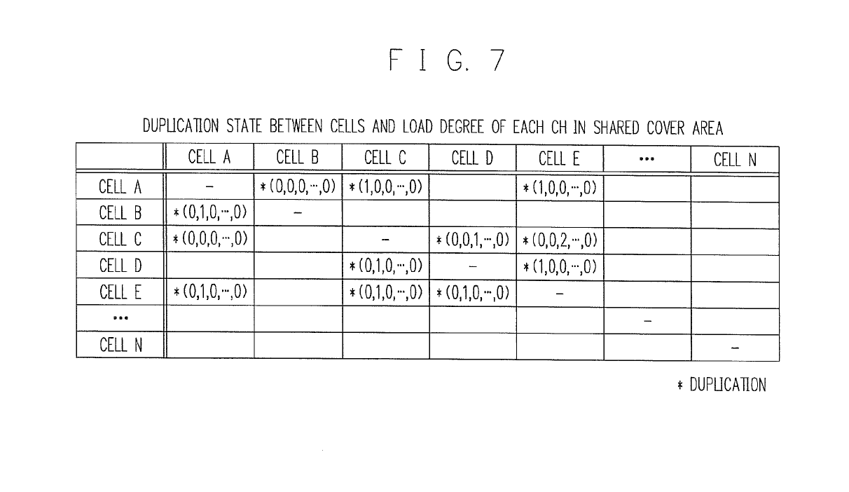

FIG. 7 is a diagram showing a table configuration example of cell duplication information stored in the data storage (150) and showing a duplication state (overlapping) between the respective cells and load degrees of used channels between the cells.

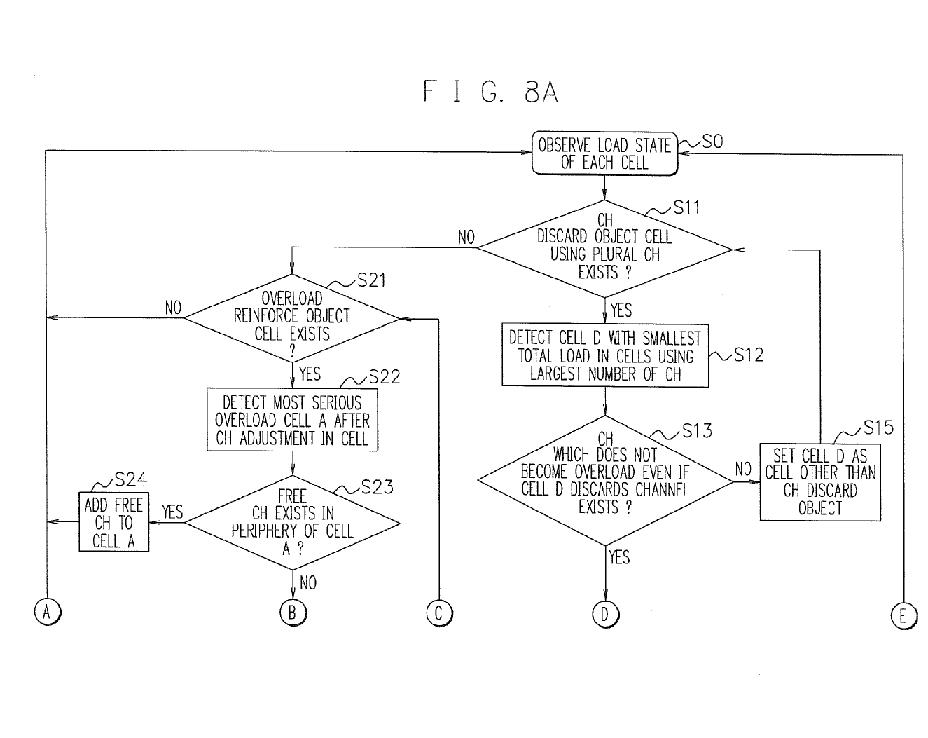

FIG. 8 is a flowchart showing a processing operation of the load distribution method in the embodiment.

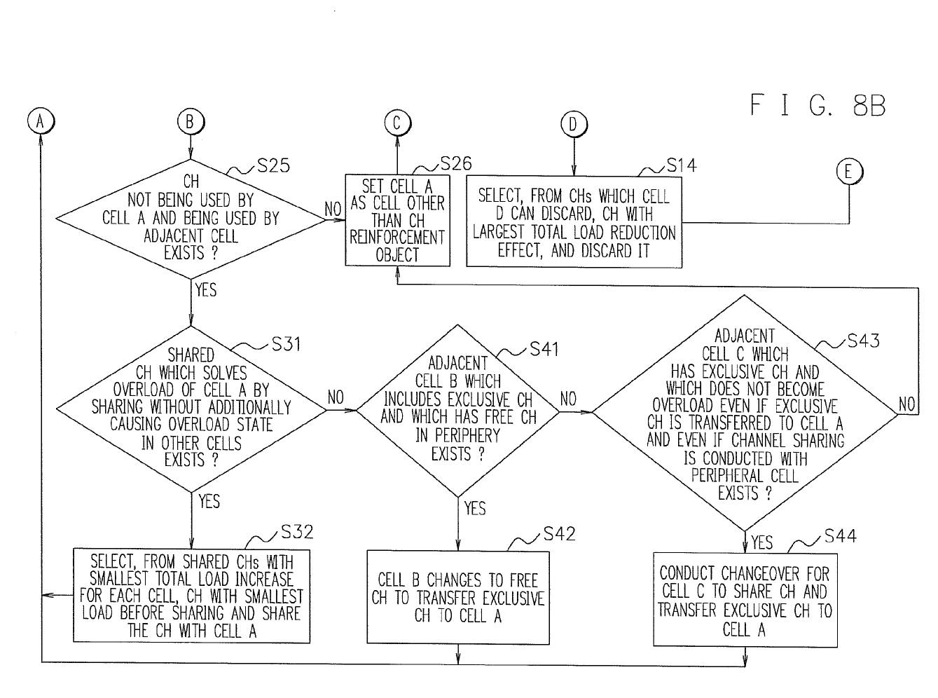

FIG. 9 is a diagram showing a graph notation which is used to explain the embodiment employing the load distribution method of the embodiment.

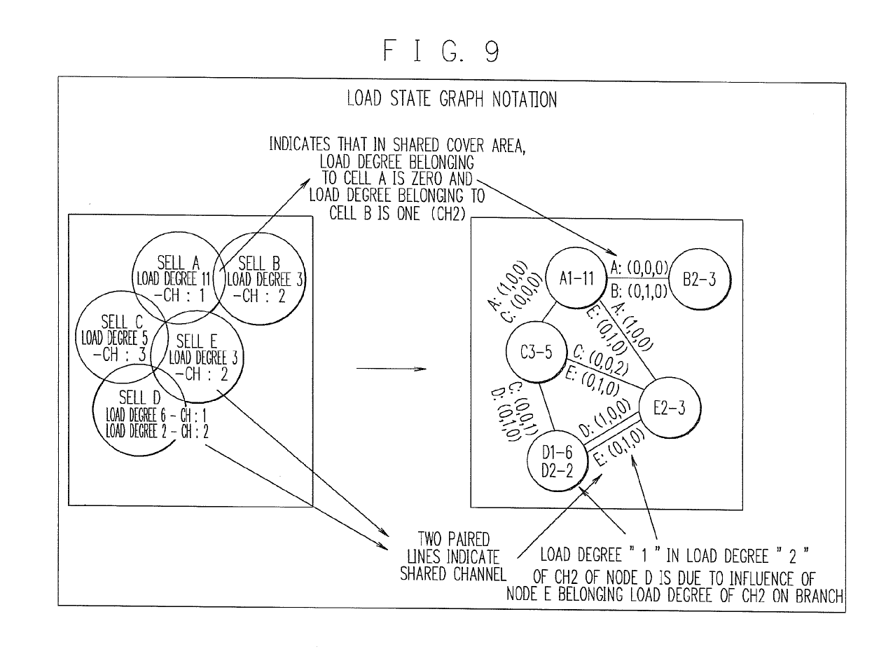

FIG. 10 is a diagram showing an operation process of embodiment A to which the load distribution method of the embodiment is applied.

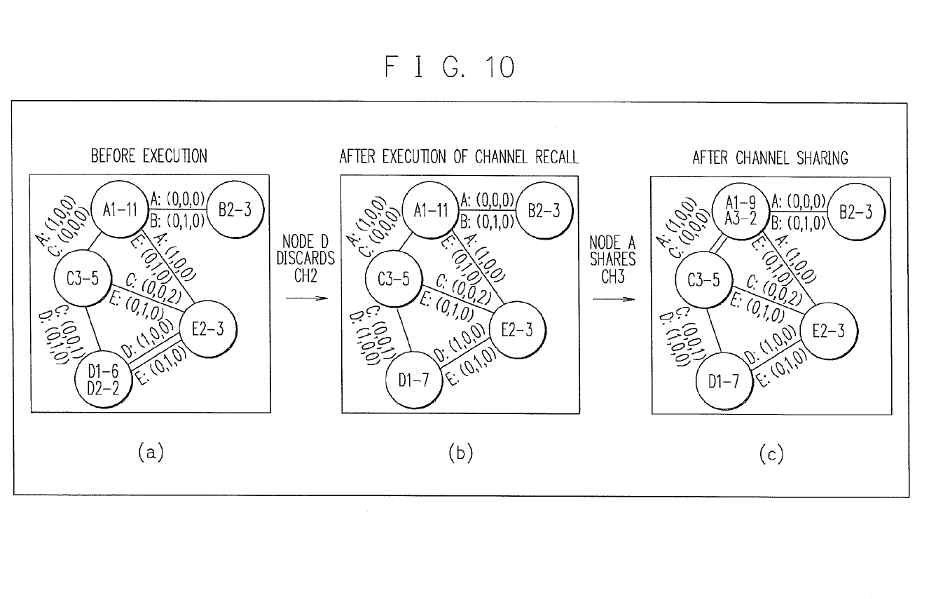

FIG. 11 is a diagram showing an operation process of embodiment B to which the load distribution method of the embodiment is applied.

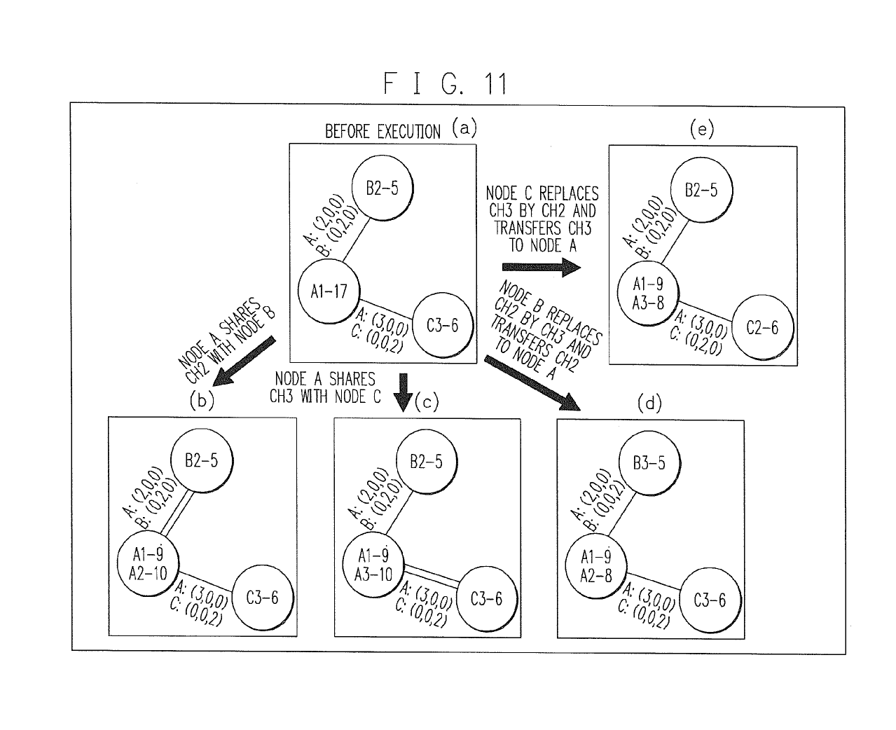

FIG. 12 is a diagram showing a system configuration of a wireless communication system in a second exemplary embodiment.

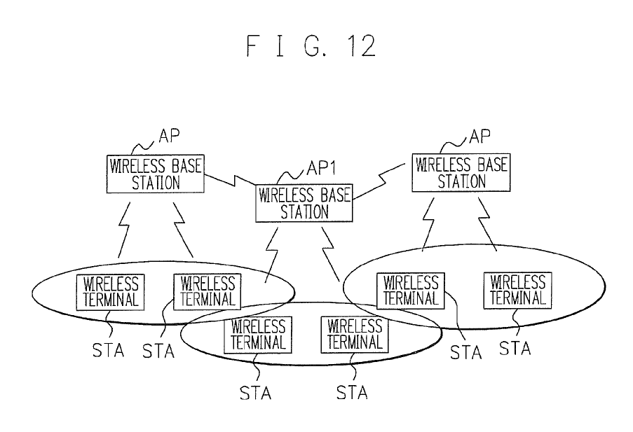

### DESCRIPTION OF REFERENCE NUMERALS

1 Load distribution apparatus
AP Wireless base station
STA Wireless terminal
11 Load degree measuring module
12 Load degree information input module
13 Cell duplication measuring module
14 Cell duplication information input module
15 Channel allocation determination module
150 Data storage
151 Channel allocation calculation module
16 Channel allocation control module

1. A wireless base station capable of allocating a plurality of radio channels to be used for wireless communication, characterized by comprising:
an allocation state acquiring unit that acquires allocation states of radio channels of adjacent wireless base stations adjacent to the wireless base station;
a load detecting unit that detects an overload radio channel in an overload state in radio channels being used by the wireless base station; and
a load distributing unit that allocates a new radio channel on the basis of the allocation states acquired by the allocation state acquiring unit and conducts load distribution for the overload radio channel;
wherein:
the load distributing unit comprises at least one of allocating units including:
a first allocating unit that allocates, as a new radio channel, a radio channel not being used in the adjacent wireless base station;
a second allocating unit that allocates, as a new radio channel, a radio channel being used in the adjacent wireless base station; and
a third allocating unit that allocates, as a new radio channel, an exclusive radio channel which is a radio channel not being used in the wireless base station and which is being exclusively used in the adjacent wireless base station.

2. (canceled)

3. The wireless base station in accordance with claim 1, characterized in that:
the third allocating unit controls such that the adjacent wireless base station is changed over to a new radio channel and the exclusive channel of the adjacent wireless base station is transferred to the wireless base station, to thereby allocate the exclusive channel as a new radio channel.

4. The wireless base station in accordance with claim 1, characterized in that:
the load distributing unit allocates, on the basis of the allocation states, the new radio channel by the first allocating unit if there exists a radio channel not being used in the adjacent wireless base station.

5. The wireless base station in accordance with claim 1, characterized in that:
the load distributing unit allocates, on the basis of the allocation states, the new radio channel by the second or third allocating unit if there does not exist a radio channel not being used in the adjacent wireless base station.

6. The wireless base station in accordance with claim 1, characterized in that:
the load distributing unit allocates, on the basis of the allocation states, the new radio channel by the third allocating unit if there exists the overload radio channel in the adjacent wireless base station.

7. The wireless base station in accordance with claim 1, characterized in that:
the load distributing unit allocates, without causing the overload radio channel to exist in the adjacent wireless base station, the new radio channel by the second or third allocating unit.

8. The wireless base station in accordance with claim 7, characterized in that:
the load distributing unit allocates the new radio channel by the third allocating unit if it is not possible to allocate the new radio channel by the second allocating unit without causing the overload radio channel to exist in the adjacent wireless base station.

9. The wireless base station in accordance with claim 1, characterized in that:
the third allocating unit comprises
a first detecting unit that detects the adjacent wireless base station in which a radio channel exists, the radio channel not being used in a wireless base station in a periphery of the adjacent wireless base station having the exclusive channel.

10. The wireless base station in accordance with claim 1, characterized in that:
the third allocating unit comprises
a second detecting unit that detects the adjacent wireless base station which does not cause the overload radio channel to exist in a state wherein the adjacent wireless base station having the exclusive channel and the wireless base station in a periphery of the adjacent wireless base station are sharing a radio channel other than the exclusive channel.

11. The wireless base station in accordance with claim 10, characterized in that:
the third allocating unit conducts the detection if it is not possible to detect, by the first detecting unit, the adjacent wireless base station in which the radio channel being not used in the peripheral wireless base station exists.

12. The wireless base station in accordance with claim 1, characterized by comprising:
a channel discarding unit that detects, in a state wherein the radio channel being used by the wireless base station is discarded, the radio channel which does not cause the overload radio channel to exist.

13. A load distribution apparatus connected to a plurality of wireless base stations capable of allocating a plurality of radio channels to be used for wireless communication for conducting load distribution for a radio channel being used in the wireless base stations, characterized by comprising:
an allocation state acquiring unit that acquires allocation states of radio channels of respective wireless base stations;
a load detecting unit that detects an overload wireless base station using an overload radio channel in an overload state on the basis of the allocation states acquired by the allocation state acquiring unit; and
a load distributing unit that allocates a new radio channel to the overload wireless base station on the basis of the allocation states acquired by the allocation state acquiring unit and conducts load distribution for the overload radio channel.
wherein:
the load distributing unit comprises at least one of allocating units including:
a first allocating unit that allocates a radio channel not being used in the adjacent wireless base station adjacent to the overload wireless base station, as a new radio channel to the overload wireless base station;
a second allocating unit that allocates a radio channel being used in the adjacent wireless base station, as a new radio channel to the overload wireless base station; and
a third allocating unit that allocates, an exclusive radio channel which is a radio channel not being used in the overload wireless base station and which is being exclusively used in the adjacent wireless base station, as a new radio channel to the overload wireless base station.

14. (canceled)

15. The load distribution apparatus in accordance with claim 13, characterized in that:
the third allocating unit controls such that the adjacent wireless base station is changed over to a new radio channel and the exclusive channel of the adjacent wireless base station is transferred to the overload wireless base station, to thereby allocate the exclusive channel as a new radio channel to the overload wireless base station.

16. The load distribution apparatus in accordance with claim 13, characterized in that:
the load distributing unit allocates, on the basis of the allocation states, the new radio channel to the overload wireless base station by the first allocating unit if there exists a radio channel not being used in the adjacent wireless base station.

17. The load distribution apparatus in accordance with claim 13, characterized in that:
the load distributing unit allocates, on the basis of the allocation states, the new radio channel to the overload wireless base station by the second or third allocating unit if there does not exist a radio channel not being used in the adjacent wireless base station.

18. The load distribution apparatus in accordance with claim 13, characterized in that:
the load distributing unit allocates, on the basis of the allocation states, the new radio channel to the overload wireless base station by the third allocating unit if there exists the overload radio channel in the adjacent wireless base station.

19. The load distribution apparatus in accordance with claim 13, characterized in that:
the load distributing unit allocates, without causing the overload radio channel to exist in the adjacent wireless base station, the new radio channel to the overload wireless base station by the second or third allocating unit.

20. The load distribution apparatus in accordance with claim 19, characterized in that:
the load distributing unit allocates the new radio channel to the overload wireless base station by the third allocating unit if it is not possible to allocate the new radio channel to the overload wireless base station by the second allocating unit without causing the overload radio channel to exist in the adjacent wireless base station.

21. The load distribution apparatus in accordance with claim 13, characterized in that:
the third allocating unit comprises
a first detecting unit that detects the adjacent wireless base station in which a radio channel exists, the radio channel not being used in a wireless base station in a periphery of the adjacent wireless base station having the exclusive channel.

22. The load distribution apparatus in accordance with claim 13, characterized in that:
the third allocating unit comprises
a second detecting unit that detects the adjacent wireless base station which does not cause the overload radio channel to exist in a state wherein the adjacent wireless base station having the exclusive channel and the wireless base station in a periphery of the adjacent wireless base station are sharing a radio channel other than the exclusive channel.

23. The load distribution apparatus in accordance with claim 22, characterized in that:
the third allocating unit conducts the detection if it is not possible to detect, by the first detecting unit, the adjacent wireless base station in which the radio channel being not used in the peripheral wireless base station exists.

24. The load distribution apparatus in accordance with claim 13, characterized by comprising:
a channel discarding unit that detects on the basis of the allocation states, in a state wherein the radio channel being used by the wireless base station is discarded, a wireless base station which does not cause the overload radio channel to exist and controls the detected wireless base station to discard the radio channel.

25. The centralized control apparatus on which a load distribution apparatus in accordance with claim 13 is mounted, characterized by comprising:
a wireless base station control unit that conducts centralized control of the plural wireless base stations.

26. The wireless base station characterized in that;
a load distribution apparatus in accordance with claim 13 is mounted in the apparatus.

27. A wireless communication system comprising a plurality of wireless base stations capable of allocating a plurality of radio channels to be used for wireless communication, characterized in that
the wireless base station comprises;
an allocation state acquiring unit that acquires allocation states of radio channels of adjacent wireless base stations adjacent to the wireless base station;
a load detecting unit that detects an overload radio channel in an overload state in radio channels being used by the wireless base station; and
a load distributing unit that allocates a new radio channel on the basis of the allocation states acquired by the allocation state acquiring unit and conducts load distribution for the overload radio channel.
wherein:
the load distributing unit comprises at least one of allocating units including:
a first allocating unit that allocates a radio channel not being used in the adjacent wireless base station adjacent to the overload wireless base station, as a new radio channel to the overload wireless base station;
a second allocating unit that allocates a radio channel being used in the adjacent wireless base station, as a new radio channel to the overload wireless base station; and
a third allocating unit that allocates, an exclusive radio channel which is a radio channel not being used in the overload wireless base station and which is being exclusively used in the adjacent wireless base station, as a new radio channel to the overload wireless base station.

28. A wireless communication system comprising a plurality of wireless base stations capable of allocating a plurality of radio channels to be used for wireless communication, characterized in that
the wireless base station comprises:
an allocation state acquiring unit that acquires allocation states of radio channels of respective wireless base stations;
a load detecting unit that detects an overload wireless base station using an overload radio channel in an overload state on the basis of the allocation states acquired by the allocation state acquiring unit; and
a load distributing unit that allocates a new radio channel to the overload wireless base station on the basis of the allocation states acquired by the allocation state acquiring unit and conducts load distribution for the overload radio channel.
wherein;
the load distributing unit comprises at least one of allocating units including:
a first allocating unit that allocates a radio channel not being used in the adjacent wireless base station adjacent to the overload wireless base station, as a new radio channel to the overload wireless base station;
a second allocating unit that allocates a radio channel being used in the adjacent wireless base station, as a new radio channel to the overload wireless base station; and
a third allocating unit that allocates, an exclusive radio channel which is a radio channel not being used in the overload wireless base station and which is being exclusively used in the adjacent wireless base station, as a new radio channel to the overload wireless base station.

29. A wireless communication system comprising a plurality of wireless base stations capable of allocating a plurality of radio channels to be used for wireless communication and a load distribution apparatus for conducting load distribution for a radio channel being used in the wireless base stations, characterized in that
load distribution apparatus comprises;
an allocation state acquiring unit that acquires allocation states of radio channels of respective wireless base stations;
a load detecting unit that detects an overload wireless base station using an overload radio channel in an overload state on the basis of the allocation states acquired by the allocation state acquiring unit; and
a load distributing unit that allocates a new radio channel to the overload wireless base station on the basis of the allocation states acquired by the allocation state acquiring unit and conducts load distribution for the overload radio channel.
wherein:
the load distributing unit comprises at least one of allocating units including:
a first allocating unit that allocates a radio channel not being used in the adjacent wireless base station adjacent to the overload wireless base station, as a new radio channel to the overload wireless base station;
a second allocating unit that allocates a radio channel being used in the adjacent wireless base station, as a new radio channel to the overload wireless base station; and
a third allocating unit that allocates, an exclusive radio channel which is a radio channel not being used in the overload wireless base station and which is being exclusively used in the adjacent wireless base station, as a new radio channel to the overload wireless base station.

30. The wireless communication system in accordance with claim 29, characterized in that:
the load distribution apparatus is a centralized control apparatus for conducting centralized control of the plural wireless base stations.

31. A load distribution method for use in a wireless base station capable of allocating a plurality of radio channels to be used for wireless communication, characterized in that the wireless base station carries out:
an allocation state acquiring step of acquiring allocation states of radio channels of adjacent wireless base stations adjacent to the wireless base station;
a load detecting step of detecting an overload radio channel in an overload state in radio channels being used by the wireless base station; and
a load distributing step of allocating a new radio channel on the basis of the allocation states acquired by the allocation state acquiring step and conducting load distribution for the overload radio channel.
wherein:
the load distributing step comprises at least one of allocating steps including:
a first allocating step of allocating a radio channel not being used in the adjacent wireless base station adjacent to the overload wireless base station, as a new radio channel to the overload wireless base station;
a second allocating step of allocating a radio channel being used in the adjacent wireless base station, as a new radio channel to the overload wireless base station; and
a third allocating step of allocating, an exclusive radio channel which is a radio channel not being used in the overload wireless base station and which is being exclusively used in the adjacent wireless base station, as a new radio channel to the overload wireless base station.

32. A load distribution method for use with a load distribution apparatus connected to a plurality of wireless base stations capable of allocating a plurality of radio channels to be used for wireless communication for conducting load distribution for a radio channel being used in the wireless base stations, characterized in that the load distribution apparatus carries out:
an allocation state acquiring step of acquiring allocation states of radio channels of respective wireless base stations;
a load detecting step of detecting an overload wireless base station using an overload radio channel in an overload state on the basis of the allocation states acquired by the allocation state acquiring step; and
a load distributing step of allocating a new radio channel to the overload wireless base station on the basis of the allocation states acquired by the allocation state acquiring step and conducting load distribution for the overload radio channel.
wherein:
the load distributing step comprises at least one of allocating steps including:
a first allocating step of allocating a radio channel not being used in the adjacent wireless base station adjacent to the overload wireless base station, as a new radio channel to the overload wireless base station;
a second allocating step of allocating a radio channel being used in the adjacent wireless base station, as a new radio channel to the overload wireless base station; and
a third allocating step of allocating, an exclusive radio channel which is a radio channel not being used in the overload wireless base station and which is being exclusively used in the adjacent wireless base station, as a new radio channel to the overload wireless base station.

33. A computer-readable medium storing a load distribution program to be executed in a wireless base station capable of allocating a plurality of radio channels to be used for wireless communication, characterized in that the wireless base station is made to execute:
allocation state acquiring processing of acquiring allocation states of radio channels of adjacent wireless base stations adjacent to the wireless base station;
load detecting processing of detecting an overload radio channel in an overload state in radio channels being used by the wireless base station; and
load distributing processing of allocating a new radio channel on the basis of the allocation states acquired by the allocation state acquiring processing and conducting load distribution for the overload radio channel.
wherein:
the load distributing processing comprises at least one of allocating processing including:
a first allocating processing of allocating a radio channel not being used in the adjacent wireless base station adjacent to the overload wireless base station, as a new radio channel to the overload wireless base station;
a second allocating processing of allocating a radio channel being used in the adjacent wireless base station, as a new radio channel to the overload wireless base station; and
a third allocating processing of allocating, an exclusive radio channel which is a radio channel not being used in the overload wireless base station and which is being exclusively used in the adjacent wireless base station, as a new radio channel to the overload wireless base station.

34. A computer-readable medium storing a load distribution program to be executed in a load distribution apparatus connected to a plurality of wireless base stations capable of allocating a plurality of radio channels to be used for wireless communication for conducting load distribution for a radio channel being used in the wireless base stations, characterized in that the load distribution apparatus is made to execute:
allocation state acquiring processing of acquiring allocation states of radio channels of respective wireless base stations;
load detecting processing of detecting an overload wireless base station using an overload radio channel in an overload state on the basis of the allocation states acquired by the allocation state acquiring processing; and
load distributing processing of allocating a new radio channel to the overload wireless base station on the basis of the allocation states acquired by the allocation state acquiring processing and conducting load distribution for the overload radio channel.
wherein:
the load distributing processing comprises at least one of allocating processing including:
a first allocating processing of allocating a radio channel not being used in the adjacent wireless base station adjacent to the overload wireless base station, as a new radio channel to the overload wireless base station;
a second allocating processing of allocating a radio channel being used in the adjacent wireless base station, as a new radio channel to the overload wireless base station; and
a third allocating processing of allocating, an exclusive radio channel which is a radio channel not being used in the overload wireless base station and which is being exclusively used in the adjacent wireless base station, as a new radio channel to the overload wireless base station.

35. A wireless base station capable of allocating a plurality of radio channels to be used for wireless communication, characterized by comprising:
allocation state acquiring means for acquiring allocation states of radio channels of adjacent wireless base stations adjacent to the wireless base station;
load detecting means for detecting an overload radio channel in an overload state in radio channels being used by the wireless base station; and
load distributing means for allocating a new radio channel on the basis of the allocation states acquired by the allocation state acquiring means and conducting load distribution for the overload radio channel.
wherein:
the load distributing means comprises at least one of allocating means including:
a first allocating means for allocating a radio channel not being used in the adjacent wireless base station adjacent to the overload wireless base station, as a new radio channel to the overload wireless base station;
a second allocating means for allocating a radio channel being used in the adjacent wireless base station, as a new radio channel to the overload wireless base station; and
a third allocating means for allocating, an exclusive radio channel which is a radio channel not being used in the overload wireless base station and which is being exclusively used in the adjacent wireless base station, as a new radio channel to the overload wireless base station.

36. A load distribution apparatus connected to a plurality of wireless base stations capable of allocating a plurality of radio channels to be used for wireless communication for conducting load distribution for a radio channel being used in the wireless base stations, characterized by comprising:
allocation state acquiring means for acquiring allocation states of radio channels of respective wireless base stations;
load detecting means for detecting an overload wireless base station using an overload radio channel in an overload state on the basis of the allocation states acquired by the allocation state acquiring means; and
load distributing means for allocating a new radio channel to the overload wireless base station on the basis of the allocation states acquired by the allocation state acquiring means and conducting load distribution for the overload radio channel.
wherein:
the load distributing means comprises at least one of allocating means including:
a first allocating means for allocating a radio channel not being used in the adjacent wireless base station adjacent to the overload wireless base station, as a new radio channel to the overload wireless base station;
a second allocating means for allocating a radio channel being used in the adjacent wireless base station, as a new radio channel to the overload wireless base station; and
a third allocating means for allocating, an exclusive radio channel which is a radio channel not being used in the overload wireless base station and which is being exclusively used in the adjacent wireless base station, as a new radio channel to the overload wireless base station.

37. A wireless communication system comprising a plurality of wireless base stations capable of allocating a plurality of radio channels to be used for wireless communication, characterized in that
the wireless base station comprises:
allocation state acquiring means for acquiring allocation states of radio channels of adjacent wireless base stations adjacent to the wireless base station;
load detecting means for detecting an overload radio channel in an overload state in radio channels being used by the wireless base station; and
load distributing means for allocating a new radio channel on the basis of the allocation states acquired by the allocation state acquiring means and conducting load distribution for the overload radio channel.
wherein:
the load distributing means comprises at least one of allocating means including:
a first allocating means for allocating a radio channel not being used in the adjacent wireless base station adjacent to the overload wireless base station, as a new radio channel to the overload wireless base station;
a second allocating means for allocating a radio channel being used in the adjacent wireless base station, as a new radio channel to the overload wireless base station; and
a third allocating means for allocating, an exclusive radio channel which is a radio channel not being used in the overload wireless base station and which is being exclusively used in the adjacent wireless base station, as a new radio channel to the overload wireless base station.

38. A wireless communication system comprising a plurality of wireless base stations capable of allocating a plurality of radio channels to be used for wireless communication, characterized in that
the wireless base station comprises:
allocation state acquiring means for acquiring allocation states of radio channels of respective wireless base stations;
load detecting means for detecting an overload wireless base station using an overload radio channel in an overload state on the basis of the allocation states acquired by the allocation state acquiring means; and
load distributing means for allocating a new radio channel to the overload wireless base station on the basis of the allocation states acquired by the allocation state acquiring means and conducting load distribution for the overload radio channel.
wherein:
the load distributing means comprises at least one of allocating means including:
a first allocating means for allocating a radio channel not being used in the adjacent wireless base station adjacent to the overload wireless base station, as a new radio channel to the overload wireless base station;
a second allocating means for allocating a radio channel being used in the adjacent wireless base station, as a new radio channel to the overload wireless base station; and
a third allocating means for allocating, an exclusive radio channel which is a radio channel not being used in the overload wireless base station and which is being exclusively used in the adjacent wireless base station, as a new radio channel to the overload wireless base station.

39. A wireless communication system comprising a plurality of wireless base stations capable of allocating a plurality of radio channels to be used for wireless communication and a load distribution apparatus for conducting load distribution for a radio channel being used in the wireless base stations, characterized in that
load distribution apparatus comprises:
allocation state acquiring means for acquiring allocation states of radio channels of respective wireless base stations;
load detecting means for detecting an overload wireless base station using an overload radio channel in an overload state on the basis of the allocation states acquired by the allocation state acquiring means; and
load distributing means for allocating a new radio channel to the overload wireless base station on the basis of the allocation states acquired by the allocation state acquiring means and conducting load distribution for the overload radio channel.
wherein:
the load distributing means comprises at least one of allocating means including:
a first allocating means for allocating a radio channel not being used in the adjacent wireless base station adjacent to the overload wireless base station, as a new radio channel to the overload wireless base station;
a second allocating means for allocating a radio channel being used in the adjacent wireless base station, as a new radio channel to the overload wireless base station; and
a third allocating means for allocating, an exclusive radio channel which is a radio channel not being used in the overload wireless base station and which is being exclusively used in the adjacent wireless base station, as a new radio channel to the overload wireless base station.
